(19) United States
(12) Patent Application Publication
(10) Pub. No.: US 2026/0241980 A1
(43) Pub. Date: Aug. 20, 2026

(54) METHOD AND SYSTEM FOR DETERMINING LINEAR POSITION OF RACK BAR

(71) Applicant: HL MANDO CORPORATION, Gyeonggi-do (KR)

(72) Inventor: Jihoon PARK, Gyeonggi-do (KR)

(21) Appl. No.: 19/542,634

(22) Filed: Feb. 17, 2026

(30) Foreign Application Priority Data
Feb. 18, 2025 (KR) 10-2025-0020611
Dec. 3, 2025 (KR) 10-2025-0188876

(51) Int. Cl. B62D 5/00; B62D 5/04; G01D 5/14

(52) U.S. Cl. CPC B62D 5/001; B62D 5/0424; B62D 5/046; G01D 5/145

(57) ABSTRACT

A method and system determine a linear position of a rack bar by receiving a first position of a first motor from a first motor sensor configured to detect a rotational position of the first motor and a second position of a second motor from a second motor sensor configured to detect a rotational position of the second motor, determining a section where a rack bar is located, from among a plurality of sections dividing a movable range of the rack bar, based on a measured rack force or a measured angle of a vehicle wheel, and determining a linear position of the rack bar based on the first position of the first motor, the second position of the second motor, and the section where the rack bar is located among the plurality of sections dividing the movable range of the rack bar.

### CROSS-REFERENCE TO RELATED APPLICATIONS

This application claims the priorities to and benefits of Korean Patent Application No. 10-2025-0020611, filed on Feb. 18, 2025, and Korean Patent Application No. 10-2025-0188876, filed on Dec. 3, 2025, in the Korean Intellectual Property Office, the disclosures of which are incorporated herein by reference in their entireties.

### BACKGROUND

### Field

Some embodiments of the present disclosure generally relate to a method and system for determining a linear position of a rack bar of a vehicle.

### Description of the Related Art

Power steering systems have been used in a vehicle steering system to provide convenience in a driving operation by assisting an operating force applied to a steering wheel by a driver. The power steering system may include a hydraulic system that utilizes hydraulic pressure, an electro-hydraulic system that utilizes both hydraulic and motor-driven power, and an electric system that utilizes only motor-driven power.

Recently, a steer-by-wire (SBW) steering system has been developed. The SBW steering apparatus uses an electric motor such as a motor for steering the vehicle and may not have a mechanical connection between a steering wheel and road wheels such as a steering shaft, universal joint, or pinion shaft.

The SBW steering system may need a rack position sensor to determine a linear position of the rack bar. Furthermore, in the steer-by-wire system, the absence of a pinion gear may cause the rack bar to rotate unintentionally.

In particular, if the pinion gear is removed for cost reduction or weight reduction, a rack position sensor may be also removed, making it difficult to accurately determine the linear position of the rack bar.

### SUMMARY

Some embodiments of the present disclosure may provide a method and apparatus for determining an accurate linear position of a rack bar.

In particular, certain embodiments the present disclosure may determine an accurate linear position of a rack bar even in the absence of a rack position sensor.

According to an embodiment of the present disclosure, there is provided a steer-by-wire system including: a ball nut that rotates while being coupled to a rack bar via a ball and slides the rack bar in an axial direction; a first nut pulley provided on an outer peripheral surface of the ball nut; a second nut pulley provided on the outer peripheral surface of the ball nut; a first motor pulley coupled to a first motor and connected to the first nut pulley via a first belt; a second motor pulley coupled to a second motor and connected to the second nut pulley via a second belt; and an electronic control device that computes the sliding position of the rack bar using a first position value detected from a first motor sensor that detects a rotational position of a shaft of the first motor, a second position value detected from a second motor sensor that detects a rotational position of a shaft of the second motor, and section information.

Here, the electronic control device may check section information in which the rack bar is located based on a measured rack force value or measured wheel angle information among sections of the rack bar that are divided into two or more sections according to a movement range of the rack bar, and determine sliding position information of the rack bar using relative sliding position information determined using the first position value and the second position value and the section information.

According to an embodiment of the present disclosure, there is provided a method for determining a sliding position of a rack bar, the method including: receiving a first position value detected from a first motor sensor that detects a rotational position of a shaft of a first motor and a second position value detected from a second motor sensor that detects the rotational position of a shaft of a second motor; checking section information in which the rack bar is located based on a measured rack force value or measured wheel angle information among sections of the rack bar that are divided into two or more sections according to a movement range of the rack bar; and determining sliding position information of the rack bar using relative sliding position information determined using the first position value and the second position value and the section information.

According to an embodiment of the present disclosure, there is provided an apparatus for determining a sliding position of a rack bar, the apparatus including: a memory storing instructions for an operation of a device computing the sliding position of the rack bar; and at least one processor that executes the instructions, in which the processor performs receiving a first position value detected from a first motor sensor that detects a rotational position of a shaft of a first motor and a second position value detected from a second motor sensor that detects the rotational position of a shaft of a second motor, checking section information in which the rack bar is located based on a measured rack force value or measured wheel angle information among sections of the rack bar that are divided into two or more sections according to a movement range of the rack bar, and determining sliding position information of the rack bar using relative sliding position information determined using the first position value and the second position value and the section information.

A method and apparatus according to some embodiments of the present disclosure may determine an accurate linear position of a rack bar.

In particular, a method and apparatus according to an embodiment of the present disclosure, may be capable of determining an accurate linear position of a rack bar even in the absence of a rack position sensor.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a schematic view schematically illustrating a steering apparatus according to an embodiment of the present disclosure;

FIGS. 2 to 7 are partial views illustrating a steering apparatus according to embodiments of the present disclosure;

FIG. 8 is a schematic view schematically illustrating a steering apparatus according to an embodiment of the present disclosure;

FIGS. 9 to 18 are partial views illustrating a steering apparatus according to an embodiment of the present disclosure;

FIG. 19 is a graph for explaining a method of estimating a rack bar position in accordance with a difference between first rotation information of a first motor and second rotation information of a second motor according to an embodiment of the present disclosure;

FIG. 20 is a graph for illustrating a method for determining a linear or sliding position of a rack bar using a motor rotational position according to an embodiment of the present disclosure;

FIG. 21 is a graph for illustrating the results of determining a linear or sliding position of a rack bar according to a motor rotational position in a high reduction ratio situation according to an embodiment of the present disclosure;

FIG. 22 is a diagram illustrating a method for determining a linear position of a rack bar using section information according to an embodiment of the present disclosure;

FIG. 23 is a graph for illustrating the setting of section information based on a rack force value according to an embodiment of the present disclosure;

FIG. 24 is a diagram for illustrating examples for the setting of section information based on an wheel angle according to an embodiment of the present disclosure;

FIG. 25 is a flowchart for illustrating a method for determining a linear position of a rack bar according to an embodiment of the present disclosure; and

FIG. 26 is a block diagram for illustrating an apparatus for determining a linear or sliding position of a rack bar according to an embodiment of the present disclosure.

### DETAILED DESCRIPTION OF THE EMBODIMENT

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

Unlike a conventional steering apparatus having a structure mechanically connecting between a steering wheel and a vehicle wheel, a steer-by-wire steering apparatus allows a vehicle to move in accordance with driver's steering control using an electronic signal of a wire. Vehicle motion control using the wire can be applied to various parts such as a brake. However, in the case of the steer-by-wire steering apparatus, stable technical support is required because there may occur a problem in that the vehicle cannot be controlled due to interruption of electronic signals. Further, technical advancements are also required in terms of miniaturization and production price reduction.

Some embodiments of the present disclosure propose various structures and control technologies that may improve stability, miniaturization, and production cost reduction in the steer-by-wire steering apparatus. For example, in certain embodiments of the present disclosure, a plurality of motors for moving a rack bar may be provided to ensure redundancy and generate appropriate torque. Exemplary embodiments of arrangement and positions of the motor and the rack bar will be described with reference to drawings.

In certain embodiments of the present disclosure, a pinion may not be included in a steer-by-wire steering apparatus is configured for cost reduction and miniaturization. However, in these embodiments, a rack bar may be rotated when the rack bar is moved by the motor. Accordingly, various embodiments of the present disclosure may provide a structure for preventing the rotary movement of the rack bar.

In addition, it is important to estimate an absolute position of the rack bar of the steer-by-wire steering apparatus to accurately steer the vehicle. However, a sensor for estimating an absolute position of the rack bar may be susceptible to damage from impact, dust, water immersion, and similar environment. In addition, a plurality of sensors may be required to ensure redundancy. Various embodiments of the present disclosure may provide configurations for estimating the position of the rack bar by using an absolute angle sensor configured to estimate the position of the rack bar or using a sensor provided in a motor or the like. In addition, some embodiments of the present disclosure may perform an operation for estimating the position of the rack bar when the position of the rack bar is estimated relatively.

The structure, the motor, the rotation prevention member, the sensor, the control operation, and the like of the steering apparatus disclosed in the present disclosure may be implemented as various embodiments for each part. Some embodiments for each part may be applied to a steering apparatus in any combination thereof.

First, embodiments of configurations of the overall structure of a steer-by-wire steering apparatus will be described.

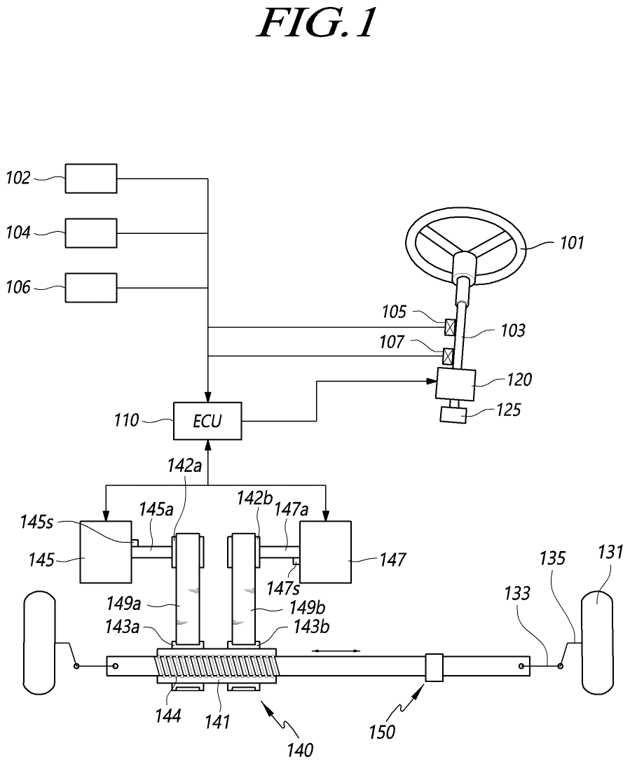

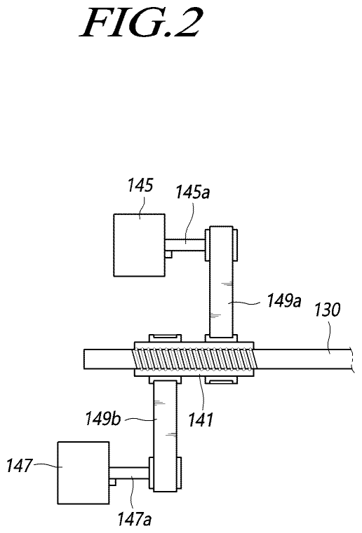

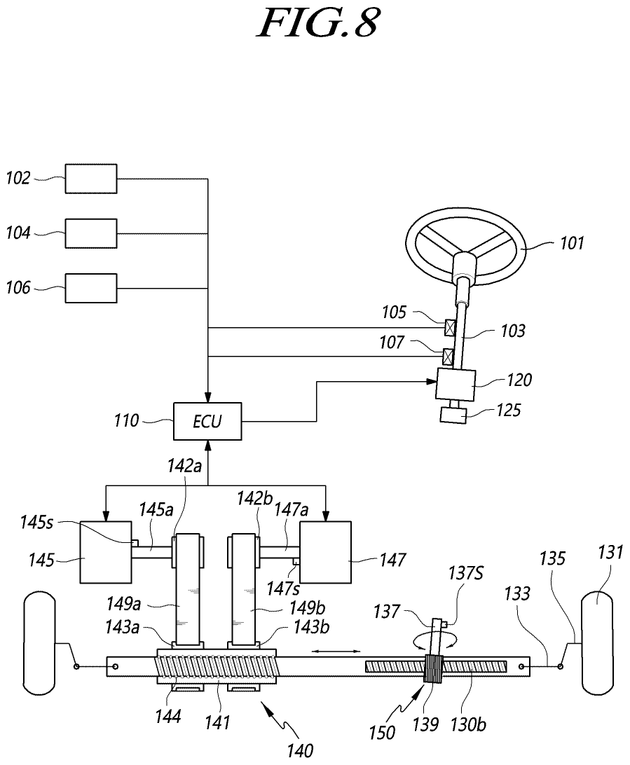

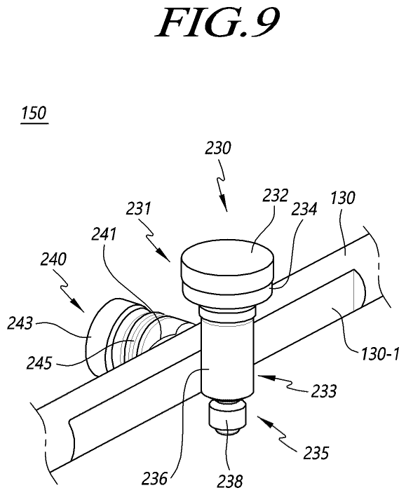

FIG. 1 is a schematic view schematically illustrating a steering apparatus according to an embodiment of the present disclosure, FIGS. 2 to 7 are partial views of a steering apparatus according to embodiments of the present disclosure, FIG. 8 is a schematic view schematically illustrating a steering apparatus according to an embodiment of the present disclosure, and FIGS. 9 to 18 are partial views of a steering apparatus according to embodiments of the present disclosure.

A steering apparatus according to an embodiment of the present disclosure includes a ball nut 141, a first nut pulley 143a, a second nut pulley 143b, a first motor pulley 142a, a second motor pulley 142b, and an electronic control device 110. The ball nut 141 may be rotatably coupled to a rack bar 130 by means of balls 144 and may be configured to slide the rack bar 130 in an axial direction by the rotation of the ball nut 141. The first nut pulley 143a may be provided on an outer peripheral surface of the ball nut 141, and the second nut pulley 143b may be provided on the outer peripheral surface of the ball nut 141. The first motor pulley 142a may be coupled to a first motor 145 (e.g. fixed to a shaft of the first motor 145) or directly formed on a rotatable part of the first motor 145 and connected to a first nut pulley 143a through a first belt 149a. The second motor pulley 142b may be coupled to a second motor 147 (e.g. fixed to a shaft of the second motor 147) or directly formed on a rotatable part of the second motor 147 and connected to the second nut pulley 143b through a second belt 149a. The electronic control device 110 may include one or more controllers or processors and may be configured to control the first and second motors 145 and 147. For instance, the electronic control device 110 output one or more control signals to the first motor 145 and the second motor 147 in response to one or more electrical signals.

With reference to FIG. 1, in a steering apparatus according to the present disclosure, an angle sensor 105 and a torque sensor 107 may be coupled to one side of a steering shaft 103 connected to a steering wheel 101 or located around the steering shaft 103.

In an autonomous driving mode in which an autonomous driving system is driving the vehicle or in a driver assistance mode in which an driver assistance system such as an Advanced Driver Assistance System (ADAS) is assisting a driver with the operation of the vehicle, the electronic control device 110 controls a steering shaft motor 120, the first motor 145, and the second motor 147 by transmitting one or more control signals to the steering shaft motor 120, the first motor 145, and the second motor 147 in response to electrical signals transmitted from various sensors mounted in or to or associated with a vehicle.

In a driver driving mode, the electronic control device 110 controls the steering shaft motor 120, the first motor 145, and the second motor 147 by outputting one or more control signals to the steering shaft motor 120, the first motor 145, and the second motor 147 in response to electrical signals transmitted from the angle sensor 105, which detects a manipulation or rotation angle of the steering wheel 101 by the driver, electrical signals transmitted from the torque sensor 107, and electrical signals transmitted from various other sensors mounted in or to or associated with the vehicle.

In an embodiment illustrated in FIG. 1, the angle sensor 105 and the torque sensor 107 are provided as two separate and individual sensors. Alternatively, the angle sensor 105 and the torque sensor 107 may be integrated into one single sensor such as one torque angle sensor.

The steering shaft motor 120 may be connected to or associated with a speed reducer configured to reduce a rotational speed of the steering shaft motor 120 including, for example, but not limited to, one or more gears, one or more pulleys, and/or one or more belts.

During normal driving, the steering shaft motor 120 provides appropriate steering feedback to the driver by providing a reaction force to the steering shaft 103 so that the driver may feel a steering reaction force against the driver's manipulation of the steering wheel 101. The steering shaft motor 120 may be also referred to as a reaction force motor. However, as described below, the steering shaft motor 120 may not only provide the reaction force but also operate in accordance with autonomous steering when the steering shaft motor 120 operates in the autonomous driving mode.

In addition, the steering shaft motor 120 rotates the steering shaft 103 so that the autonomous steering can be performed under the control of the electronic control device 110 without the involvement of the driver's driving or intention when the steering shaft motor 120 operates in the autonomous driving mode.

Further, in a steer-by-wire steering apparatus, because the steering wheel 101 is not mechanically connected to the rack bar 130 and a road wheel 131, a device for mechanically restricting or limiting a rotatable range of the steering wheel 101 may be included to prevent the steering shaft 103 from rotating infinitely when the driver manipulates the steering wheel 101.

For example, a rotation angle restriction device 125 may be provided to restrict or limit a rotatable range of the steering wheel 101 to prevent the steering shaft 103 from rotating infinitely.

The first motor 145 and the second motor 147 move the rack bar 130 or cause the rack bar 130 to slide by a rack bar moving device 140 in order to steer the road wheels 131, which are provided at or connected to two opposite sides of the rack bar 130 through tie rods 133 and knuckle arms 135 by sliding the rack bar 130.

The rack bar moving device 140 includes the ball nut 141, the first nut pulley 143a, the second nut pulley 143b, the first motor pulley 142a, and the second motor pulley 142b. The ball nut 141 may be rotatably coupled to the rack bar 130 by means of the balls 144 and configured to slide the rack bar 130 in the axial direction of the rack bar moving device 140 by the rotation of the ball nut 141. The first nut pulley 143a may be provided on one side of the outer peripheral surface of the ball nut 141, and the second nut pulley 143b may be provided on the other side of the outer peripheral surface of the ball nut 141. The first motor pulley 142a may be coupled to the first motor 145 (e.g. fixed to a shaft of the first motor 145) or directly formed on a rotatable part of the first motor 145 and connected to the first nut pulley 143a through the first belt 149a. The second motor pulley 142b may be coupled to the second motor 147 (e.g. fixed to a shaft of the second motor 147) or directly formed on a rotatable part of the second motor 147 and connected to the second nut pulley 143b through the second belt 149a.

Further, the balls 144 are rotatably disposed between a rack screw groove, which is formed on an outer peripheral surface of the rack bar 130, and a nut screw groove, formed on an inner peripheral surface of the ball nut 141, such that the rack bar 130 can slides in the axial direction of the rack bar moving device 140 by the rotation of the ball nut 141.

However, in the embodiments of the present disclosure described above, the angle sensor 105 and the torque sensor 107 are provided on or around the steering shaft 103, and the steering apparatus according to an embodiment of the present disclosure may comprise a vehicle speed sensor 102, an ultrasonic sensor 104, and an image sensor 106 for transmitting steering information to the electronic control device 110. However, various types of sensors, such as a radar and a lidar, may be added to an embodiment of the present disclosure.

In a steer-by-wire steering apparatus, because the steering wheel 101 is not mechanically connected to the rack bar 130 and the road wheel 131, a device mechanically restricting the rack bar 130 may be included to prevent the rack bar 130 from being rotated by rotational torque of the ball nut 141 rotated by the rack bar moving device 140.

For instance, a rotation prevention member 150 is configured to support the axial sliding of the rack bar 130 and prevent the rotation of the rack bar 130.

In an embodiment illustrated in FIG. 1, one single rotation prevention member 150 is provided at one side of the rack bar 130. Alternatively, a plurality of the rotation prevention members 150 may be provided to support the rack bar 130. The number of the rotation prevention members 150, an axial position of the rotation prevention member 150, or the like may vary depending on the configuration and required operations of the first and second motors 145 and 147 and necessary rotational force of the ball nut 141 of the rack bar moving device 140.

In one embodiment illustrated in FIG. 1, the first motor 145 and the second motor 147 are arranged to face each other such that a shaft 145a of the first motor 145 and a shaft 147a of the second motor 147 are aligned coaxially and disposed in parallel with a central axis of the rack bar 130.

In an another embodiment illustrated in FIG. 2, the first motor 145 is disposed on one side of the rack bar 130 and the second motor 147 is disposed on the other side of the rack bar 130 such that the rack bar 130 is positioned between the shaft 145a of the first motor 145 and the shaft 147a of the second motor 147, and the shaft 145a of the first motor 145 and the shaft 147a of the second motor 147 are disposed in parallel with the central axis of the rack bar 130 and disposed on two opposite sides of the central axis of the rack bar 130.

As described above, the exemplary arrangements of the first and second motors 145 and 147 and the rack bar 130 illustrated in FIGS. 1 and 2 may reduce the package size of the steering apparatus, making it more compact in volume, and the process of assembling of the steering apparatus the first motor 145, the first belt 149a, the second motor 147, and the second belt 149b may be simplified.

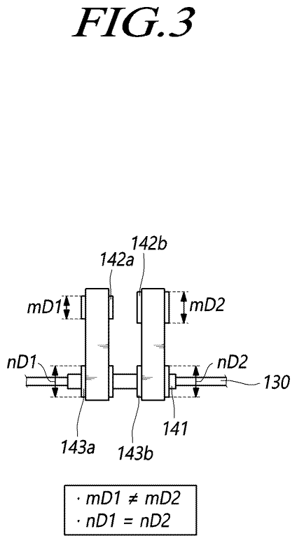

With reference to FIG. 3, an outer diameter mD1 of the first motor pulley 142a and an outer diameter mD2 of the second motor pulley 142b may be different from each other, and an outer diameter nD1 of the first nut pulley 143a and an outer diameter nD2 of the second nut pulley 143b may be equal to each other.

That is, the first nut pulley 143a and the second nut pulley 143b rotate while maintaining the same phase angle without a phase difference therebetween when the first motor 145 and the second motor 147 operate. The first motor pulley 142a and the second motor pulley 142b rotate while gradually changing a phase difference therebetween when the first motor 145 and the second motor 147 operate.

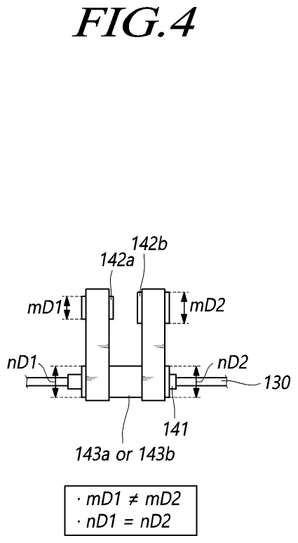

In an embodiment illustrated in FIG. 3, the first nut pulley 143a and the second nut pulley 143b are provided separately and connected to one portion and the other portion of the outer peripheral surface of the ball nut 141. However, as illustrated in FIG. 4, the first nut pulley 143a and the second nut pulley 143b may be integrated as a single piece having the same outer diameter. This will be described below.

The first motor 145 may have a first motor sensor 145s configured to detect a rotation position of the shaft 145a of the first motor 145, and the second motor 147 may have a second motor sensor 147s configured to detect a rotation position of the shaft 147a of the second motor 147.

When the first motor 145 operates, the first motor sensor 145s detects a direction and an angle of rotation of the shaft 145a of the first motor 145, and the first motor sensor 145s outputs a signal indicative of the direction and the angle to the electronic control device 110.

When the second motor 147 operates, the second motor sensor 147s detects a direction and an angle of rotation of the shaft 147a of the second motor 147, and the second motor sensor 147s outputs a signal indicative of the direction and the angle of the rotation of the shaft 147a of the second motor 147 to the electronic control device 110. When the second motor 147 operates, the second motor sensor 147s detects a direction and an angle of rotation of the shaft 147a of the second motor 147, and the second motor sensor 147s outputs a signal indicative of the direction and the angle of rotation of the shaft 147a of the second motor 147 to the electronic control device 110.

Therefore, the electronic control device 110 may determine a linear position of the rack bar 130 based on a first position of the shaft 145a of the first motor 145 detected by the first motor sensor 145s and a second position of the shaft 147a of the second motor 147 detected by the second motor sensor 147s and output a control signal to the first motor 145 and the second motor 147.

That is, the electronic control device 110 sets an angle between a reference point of the shaft 145a of the first motor 145 in a stopped state of the first motor 145 and a reference point of the shaft 147a of the second motor 147 in a stopped state of the second motor 147 to a reference position value. The electronic control device 10 sets an angle between the reference point of the shaft 145a of the first motor 145 and the reference point of the shaft 147a of the second motor 147 after the operations of the first and second motors 145 and 147 to an operating position value. The electronic control device 10 determines the linear position of the rack bar 130 based on a difference between the reference position value and the operating position value.

For instance, the difference between the reference position value and the operating position value may be set to 0° to 360°. A maximum slidable amount of the rack bar 130 is set within this range. The electronic control device 110 determines the slidable position of the rack bar 130 based on at least one of a rotation ratio between the first motor pulley 142a and the first nut pulley 143a, a rotation ratio between the second motor pulley 142b and the second nut pulley 143b, an outer diameter and an inner diameter of the ball nut 141, an outer diameter of the rack bar 130, or a lead angle between the rack screw groove 130a and the nut screw groove 141a.

In addition, the electronic control device 110 may determine the linear position of the rack bar 130 by setting the difference between the reference position value and the operating position value to a movement value and comparing the movement value with preset data. For instance, the movement value may be set to 0° to 360°, and the maximum slidable amount of the rack bar 130 may be set within this range.

The preset data may be data including the sliding amount of the rack bar 130 corresponding to the movement value determined based on at least one of the outer diameters of the first and second motor pulleys 142a and 142b, the outer diameters of the first and second nut pulleys 143a and 143b, the outer and inner diameters of the ball nut 141, and/or the outer diameter of the rack bar 130.

For example, the first motor pulley 142a and the second motor pulley 142b have different outer diameters, and the first nut pulley 143a and the second nut pulley 143b have the same outer diameter, such that the electronic control device 110 may determine the sliding position of the rack bar 130 based on the first position of the shaft 145a of the first motor 145 detected by the first motor sensor 145s and the second position of the shaft 147a of the second motor 147 detected by the second motor sensor 147s and output a signal for controlling the first motor 145 and the second motor 147.

With reference to FIG. 4, the first nut pulley 143a and the second nut pulley 143b may be integrated to a single piece having the same outer diameter.

In an example that the first nut pulley 143a and the second nut pulley 143b are integrated to a single piece having the same outer diameter, the first belt 149a is coupled to one portion of the integrated pulley, and the second belt 149b is coupled to the other portion of the integrated pulley, such that the first belt 149a and the second belt 149b may be respectively connected to the first motor pulley 142a and the second motor pulley 142b.

Further, the first motor 145 may have the first motor sensor 145s configured to detect the rotation position of the shaft 145a of the first motor 145, and the second motor 147 may have the second motor sensor 147s configured to detect the rotation position of the shaft 147a of the second motor 147.

When the first motor 145 operates, the first motor sensor 145s detects the direction and the angle of the rotation of the shaft 145a of the first motor 145, and the first motor sensor 145s transmits the direction and the angle to the electronic control device 110.

When the second motor 147 operates, the second motor sensor 147s detects the direction and the angle of the rotation of the shaft 147a of the second motor 147 rotates, and the second motor sensor 147s transmits a signal indicative of the direction and the angle to the electronic control device 110.

Therefore, the electronic control device 110 may determine the linear position of the rack bar 130 based on the first position of the shaft 145a of the first motor 145 detected by the first motor sensor 145s and the second position of the shaft 147a of the second motor 147 detected by the second motor sensor 147s and output a signal for controlling the first motor 145 and the second motor 147.

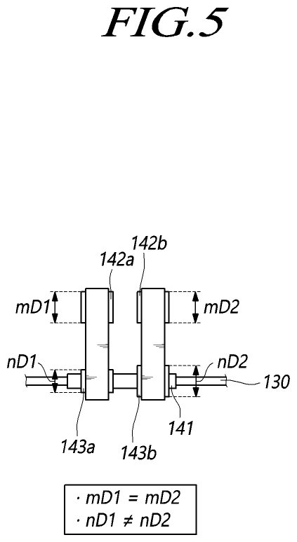

In an exemplary embodiment illustrated in FIG. 5, the outer diameter mD1 of the first motor pulley 142a and the outer diameter mD2 of the second motor pulley 142b may be equal to each other, and the outer diameter nD1 of the first nut pulley 143a and the outer diameter nD2 of the second nut pulley 143b may be different from each other.

The first nut pulley 143a, the second nut pulley 143b, and the ball nut 141 rotate at the same speed. Therefore, the first nut pulley 143a and the second nut pulley 143b maintain the same phase angle and rotate without a phase difference when the first motor 145 and the second motor 147 operate. However, the first motor pulley 142a and the second motor pulley 142b rotate while gradually changing a phase difference.

Further, the first motor 145 may have the first motor sensor 145s configured to detect the rotation position of the shaft 145a of the first motor 145, and the second motor 147 may have the second motor sensor 147s configured to detect the rotation position of the shaft 147a of the second motor 147.

When the first motor 145 operates, the first motor sensor 145s detects the direction and the angle of rotation of the shaft 145a of the first motor 145, and the first motor sensor 145s outputs a signal indicative of the direction and the angle of the rotation of the shaft 145a of the first motor 145 to the electronic control device 110.

Further, when the second motor 147 operates, the second motor sensor 147s detects the direction and the angle of rotation of the shaft 147a of the second motor 147, and the second motor sensor 147s transmits the direction and the angle of the rotation of the shaft 147a of the second motor 147 to the electronic control device 110.

Therefore, the electronic control device 110 may output a signal for controlling the first motor 145 and the second motor 147 by determining the linear position of the rack bar 130 through the above-mentioned determination process based on the first position of the shaft 145a of the first motor 145 detected by the first motor sensor 145s and the second position of the shaft 147a of the second motor 147 detected by the second motor sensor 147s.

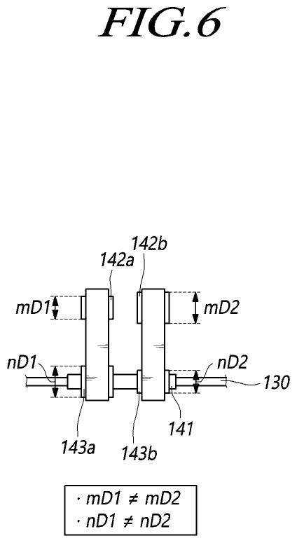

In an exemplary embodiment shown in FIG. 6, the outer diameter mD1 of the first motor pulley 142a and the outer diameter mD2 of the second motor pulley 142b may be different from each other, and the outer diameter nD1 of the first nut pulley 143a and the outer diameter nD2 of the second nut pulley 143b may also be different from each other.

Even in this case, the first nut pulley 143a, the second nut pulley 143b, and the ball nut 141 rotate at the same speed. Therefore, the first nut pulley 143a and the second nut pulley 143b maintain the same phase angle and rotate without a phase difference when the first motor 145 and the second motor 147 operate.

Further, the first motor pulley 142a and the second motor pulley 142b rotate while gradually changing a phase difference when the first motor 145 and the second motor 147 operate.

The first motor 145 may have the first motor sensor 145s configured to detect the rotation position of the shaft 145a of the first motor 145, and the second motor 147 may have the second motor sensor 147s configured to detect the rotation position of the shaft 147a of the second motor 147.

Therefore, the electronic control device 110 may output a signal for controlling the first motor 145 and the second motor 147 by determining the linear position of the rack bar 130 through the above-mentioned determination process based on the first position of the shaft 145a of the first motor 145 detected by the first motor sensor 145s and the second position of the shaft 147a of the second motor 147 detected by the second motor sensor 147s.

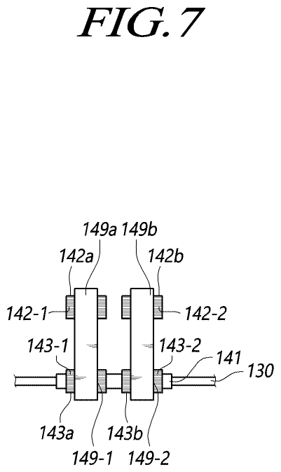

In an exemplary embodiment of FIG. 7, first motor pulley teeth 142-1 are provided on an outer peripheral surface of the first motor pulley 142a, and first nut pulley teeth 143-1 are provided on an outer peripheral surface of the first nut pulley 143a. The first motor pulley teeth 142-1 and the first nut pulley teeth 143-1 may be coupled to first belt teeth 149-1 provided on an inner peripheral surface of the first belt 149a.

Because the first motor pulley teeth 142-1 and the first nut pulley teeth 143-1 are coupled to the first belt teeth 149-1 to transmit power, the first motor pulley teeth 142-1 and the first nut pulley teeth 143-1 have the same size as the first belt teeth 149-1.

Second motor pulley teeth 142-2 are provided on an outer peripheral surface of the second motor pulley 142b, and second nut pulley teeth 143-2 are provided on an outer peripheral surface of the second nut pulley 143b. The second motor pulley teeth 142-2 and the second nut pulley teeth 143-2 may be coupled to second belt teeth 149-2 provided on an inner peripheral surface of the second belt 149b.

Because the second motor pulley teeth 142-2 and the second nut pulley teeth 143-2 are coupled to the second belt teeth 149-2 to transmit power, the second motor pulley teeth 142-2 and the second nut pulley teeth 143-2 may have the same size as the second belt teeth 149-2.

Further, the number of the first motor pulley teeth 142-1 and the number of the second motor pulley teeth 142-2 may be different from each other, and the number of the first nut pulley teeth 143-1 and the number of the second nut pulley teeth 143-2 may be equal to each other.

The first motor pulley teeth 142-1 and the second motor pulley teeth 142-2 have an equal circumferential pitch, different pitch circle diameters, and a different number of teeth from each other. The first nut pulley teeth 143-1 and the second nut pulley teeth 143-2 have an equal circumferential pitch, an equal pitch circle diameter, and a different number of teeth.

The first motor 145 may have the first motor sensor 145s configured to detect the rotation position of the shaft 145a of the first motor 145, and the second motor 147 may have the second motor sensor 147s configured to detect the rotation position of the shaft 147a of the second motor 147.

Therefore, the electronic control device 110 may determine the linear position of the rack bar 130 based on the first position of the shaft 145a of the first motor 145 detected by the first motor sensor 145s and the second position of the shaft 147a of the second motor 147 detected by the second motor sensor 147s and output a signal for controlling the first motor 145 and the second motor 147.

That is, like the above-mentioned determination method, the difference between the reference position value and the operating position value may be set to 0° to 360°, and the maximum slidable amount of the rack bar 130 is set within this range. The electronic control device 110 determines the sliding position of the rack bar 130 on the basis of at least one of a pitch circle diameter ratio or a tooth number ratio between the first motor pulley 142a and the first nut pulley 143a, a pitch circle diameter ratio or a tooth number ratio between the second motor pulley 142b and the second nut pulley 143b, the outer and inner diameters of the ball nut 141, or the outer diameter of the rack bar 130.

In addition, like the above-mentioned determination method, the electronic control device 110 may determine the sliding position of the rack bar 130 by setting the difference between the reference position value and the operating position value to the movement value and comparing the movement value with preset data. In this case, the movement value may be set to 0° to 360°, and the maximum slidable amount of the rack bar 130 is set within this range.

In this case, the preset data may be data including the sliding amount of the rack bar 130 corresponding to the movement value determined based on at least one of the pitch circle diameters and the number of teeth of the first and second motor pulleys 142a and 142b, the pitch circle diameters and the number of teeth of the first and second nut pulleys 143a and 143b, the outer and inner diameters of the ball nut 141, and/or the outer diameter of the rack bar 130. As described above, the number of the first motor pulley teeth 142-1 and the number of the second motor pulley teeth 142-2 are different, and the number of the first nut pulley teeth 143-1 and the number of the second nut pulley teeth 143-2 are equal. The electronic control device 110 may output a signal for controlling the first motor 145 and the second motor 147 by determining the sliding position of the rack bar 130 on the basis of the first position of the shaft 145a of the first motor 145 sensed by the first motor sensor 145s and the second position of the shaft 147a of the second motor 147 detected by the second motor sensor 147s.

In addition, the number of the first motor pulley teeth 142-1 and the number of the second motor pulley teeth 142-2 may be equal, and the number of the first nut pulley teeth 143-1 and the number of the second nut pulley teeth 143-2 may be different.

The first motor pulley teeth 142-1 and the second motor pulley teeth 142-2 have an equal circumferential pitch and an equal pitch circle diameter, and the same number of teeth. The first nut pulley teeth 143-1 and the second nut pulley teeth 143-2 have an equal circumferential pitch, and different pitch circle diameters and the different number of teeth.

Further, the first motor 145 may have the first motor sensor 145s configured to detect the rotation position of the shaft 145a of the first motor 145, and the second motor 147 may have the second motor sensor 147s configured to detect the rotation position of the shaft 147a of the second motor 147.

Therefore, the electronic control device 110 may output a signal for controlling the first motor 145 and the second motor 147 by determining the sliding position of the rack bar 130 through the above-mentioned determination process based on the first position of the shaft 145a of the first motor 145 detected by the first motor sensor 145s and the second position of the shaft 147a of the second motor 147 detected by the second motor sensor 147s.

In addition, the number of the first motor pulley teeth 142-1 and the number of the second motor pulley teeth 142-2 may be different, and the number of the first nut pulley teeth 143-1 and the number of the second nut pulley teeth 143-2 may be different.

That is, the first motor pulley teeth 142-1 and the second motor pulley teeth 142-2 may have an equal circumferential pitch and different pitch circle diameters, and different number of teeth. The first nut pulley teeth 143-1 and the second nut pulley teeth 143-2 have an equal circumferential pitch, different pitch circle diameters, and different number of teeth.

Further, the first motor 145 may have the first motor sensor 145s configured to detect the rotation position of the shaft 145a of the first motor 145, and the second motor 147 may have the second motor sensor 147s configured to detect the rotation position of the shaft 147a of the second motor 147.

Therefore, the electronic control device 110 may output a signal for controlling the first motor 145 and the second motor 147 by determining the sliding position of the rack bar 130 through the above-mentioned determination process based on the first position of the shaft 145a of the first motor 145 detected by the first motor sensor 145s and the second position of the shaft 147a of the second motor 147 the second motor sensor 147s.

In an exemplary embodiment of FIG. 8, in order to prepare for a case in which any one of the first motor sensor 145s and the second motor sensor 147s is inoperable, a rotary gear 139, rotatably engaged with a rack gear 130b provided on the rack bar 130, may be rotatably coupled to the rack bar 130, and a rotation angle sensor 137s may be configured to detect a rotation angle of the rotary gear 139.

The rotary gear 139 may be configured to be rotatable while being supported on a rack housing by means of a bearing. The rotation angle sensor 137s may be installed on or around a shaft 137 of the rotary gear 139 and configured to detect a rotation angle of the rotary gear 139 and transmit the rotation angle of the rotary gear 139 to the electronic control device 110. Therefore, even when any one of the first motor sensor 145s and the second motor sensor 147s is inoperable, the electronic control device 110 may output a signal for controlling the first motor 145 and the second motor 147 by determining the sliding position of the rack bar 130 based on the pre-stored gear ratio between the rack gear 130b and the rotary gear 139 and the rotation angle of the rotary gear 139 received from the rotation angle sensor 137s.

Meanwhile, hereinafter, various embodiments of a rotation prevention member or means may be provided in the above-mentioned steering apparatus.

Some embodiments of the rotation prevention member 150 will be described below more specifically with reference to FIGS. 9 to 18.

As illustrated in FIG. 9, the rotation prevention member 150 may be coupled to one radial side and the other radial side of the rack bar 130 and support two opposite sides of the rack bar 130, thereby preventing the rack bar 130 from rotating.

The rotation prevention member 150 may include a shaft 230 configured to support a support surface 130-1 formed on the outer peripheral surface of the rack bar 130, and a support yoke 240 configured to support the outer peripheral surface of the rack bar 130 opposite or corresponding to a position at which the shaft 230 is supported.

The support surface 130-1 formed on the outer peripheral surface of the rack bar 130 may be formed by machining or grinding the outer peripheral surface of the rack bar 130.

The support surface 130-1 may be recessed from the outer peripheral surface of the rack bar 130 and formed as a curved surface, a flat surface, or combination thereof.

The support surface 130-1 extends in an axial direction of the rack bar 130 so as to be supported by the shaft 230 when the rack bar 130 slides in the axial direction of the rack bar 130.

Optionally, a coating layer may be provided on the support surface 130-1 and made of a low-friction material having a low frictional coefficient, such as fluorine resin or ceramic, in order to minimize or reduce friction with the shaft 230.

The shaft 230, which supports the support surface 130-1 of the rack bar 130, may include an upper end support portion 231, a body portion 233, and a lower end support portion 235.

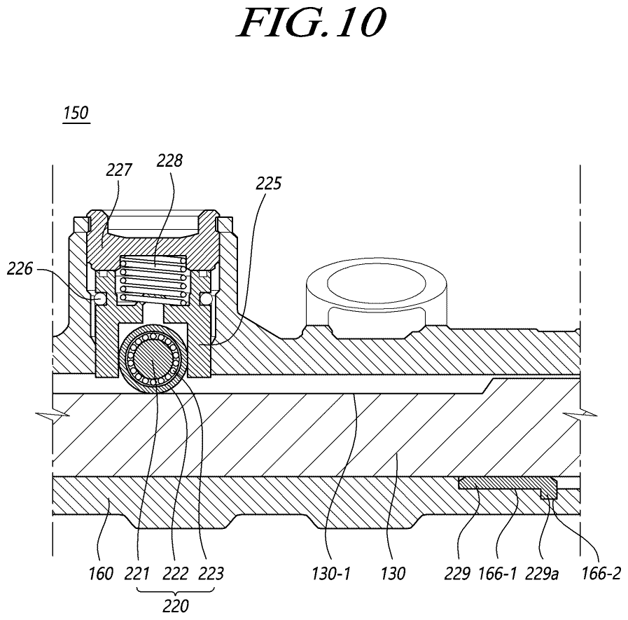

When the rack bar 130 slides, the shaft 230 is supported by a rack housing (e.g., 160 of FIG. 10) and is configured to be rotatable such that the body portion 233 supports the support surface 130-1 of the rack bar 130, thereby preventing the rack bar 130 from rotating.

A needle bearing 236 may be coupled to the body portion 233 to minimize or reduce friction with the support surface 130-1 of the rack bar 130.

The upper end support portion 231, which has a larger diameter than the body portion 233, may be provided above the body portion 233, and an upper end bearing 234 may be coupled to the upper end support portion 231 so as to be rotatably supported on the rack housing.

A top plug 232 may be coupled to an upper side of the upper end support portion 231 in order to prevent foreign substances from being introduced into the rack housing.

The lower end support portion 235, which has a smaller diameter than the body portion 233, may be provided below the body portion 233, and a lower end bearing 238 may be coupled to the lower end support portion 235 so as to be rotatably supported on the rack housing.

The support yoke 240, which supports the outer peripheral surface of the rack bar 130 opposite to a position at which the shaft 230 is supported, supports the rack bar 130 toward the shaft 230 when the rack bar 130 slides, thereby preventing the rack bar 130 from rotating.

A curved surface support portion 241 may be formed at an end portion of the support yoke 240 and may be supported on and closely contacted with the outer peripheral surface of the rack bar 130. The curved surface support portion 241 may have a curved surface identical to the outer peripheral surface of the rack bar 130.

The support yoke 240 may have predetermined rigidity and elasticity and may be made of one or more materials selected from a group consisting of polyacetal (POM), polyamide (PA), polycarbonate (PC), polyimide (PI), polybutylene terephthalate (PBT), polyphenylene sulfide (PPS), and phenol formaldehyde (PF).

An elastic ring 245 may be coupled to an outer peripheral surface of the support yoke 240 to prevent rattle noise with the rack housing.

One or more elastic rings 245 may be coupled to the outer peripheral surface of the support yoke 240.

The elastic ring 245 may be made of a material capable of absorbing vibration and noise and having predetermined elasticity and rigidity. For instance, the elastic ring 245 may be made of one or more materials selected from a group consisting of natural rubber (NR), nitrile butadiene rubber (NBR), chloroprene rubber (CR), ethylene propylene terpolymer (EPDM), fluoro-rubber (FPM), styrene butadiene rubber (SBR), chlorosulfonated polyethylene (CSM), urethane, and silicone that have the above-mentioned properties.

A yoke plug 243 may be coupled to an end portion of the support yoke 240, press-fitted or screw-coupled to the rack housing, and fix the support yoke 240.

Further, an elastic body may be coupled between the support yoke 240 and the yoke plug 243 and elastically support the support yoke 240 toward the rack bar 130.

As illustrated in FIG. 10, the rotation prevention member 150 may be coupled to one radial side and the other radial side of the rack bar 130 and support two opposite sides of the rack bar 130, thereby preventing the rack bar 130 from rotating.

The rotation prevention member 150 may include a needle bearing 220 configured to support the support surface 130-1 formed on the outer peripheral surface of the rack bar 130, a support yoke 225 rotatably coupled to the needle bearing 220, and a rack bushing 229 configured to support the outer peripheral surface of the rack bar 130 opposite to a position at which the needle bearing 220 is supported.

The support surface 130-1 may be formed on the outer peripheral surface of the rack bar 130. For instance, the support surface 130-1 may be formed by machining or grinding the outer peripheral surface of the rack bar 130.

The support surface 130-1 may be recessed from the outer peripheral surface of the rack bar 130. The support surface 130-1 may be formed as a curved surface or a flat surface.

The support surface 130-1 is elongated in the axial direction of the rack bar 130. And, the support surface 130-1 may be supported by the needle bearing 220 when the rack bar 130 slides in the axial direction of the rack bar 130.

A coating layer may be provided on the support surface 130-1 and made of a low-friction material, such as fluorine resin or ceramic, in order to minimize or reduce friction with the needle bearing 220.

The needle bearing 220 may be configured to support the support surface 130-1 of the rack bar 130, the needle bearing 220 may have a support shaft 221 provided at a central portion of the needle bearing 220, and the support shaft 221 is fixed to the support yoke 225 so that the needle bearing 220 may be rotatably supported by the support yoke 225.

An outer race 222 of the needle bearing 220 is supported on the support surface 130-1 and is configured to rotate when the rack bar 130 slides in order to prevent the rack bar 130 from rotating.

The outer race 222 of the needle bearing 220 may be disposed at a position protruding from an end portion of the support yoke 225 so that the outer race 222 may be supported on the support surface 130-1.

The support yoke 225 supports the needle bearing 220 toward the support surface 130-1 when the rack bar 130 slides in order to prevent the rotation of the rack bar 130.

The support yoke 225 may have predetermined rigidity and elasticity and made of one or more materials selected from a group consisting of polyacetal (POM), polyamide (PA), polycarbonate (PC), polyimide (PI), polybutylene terephthalate (PBT), polyphenylene sulfide (PPS), and phenol formaldehyde (PF).

An elastic ring 226 may be coupled to the outer peripheral surface of the support yoke 225 to prevent rattle noise with the rack housing 160.

One or more elastic rings 226 may be coupled to the outer peripheral surface of the support yoke 225.

The elastic ring 226 may be made of a material capable of absorbing vibration and noise and having predetermined elasticity and rigidity. Therefore, the elastic ring 226 may be made of one or more materials selected from a group consisting of natural rubber (NR), nitrile butadiene rubber (NBR), chloroprene rubber (CR), ethylene propylene terpolymer (EPDM), fluoro-rubber (FPM), styrene butadiene rubber (SBR), chlorosulfonated polyethylene (CSM), urethane, and silicone that have the above-mentioned properties.

A yoke plug 227 may be coupled to an end of the support yoke 225, press-fitted or screw-coupled to the rack housing 160, and configured to fix the position of the support yoke 225.

Further, an elastic body 228 may be coupled between the support yoke 225 and the yoke plug 227 and elastically support the support yoke 225 by applying an elastic force toward the rack bar 130.

The rack bushing 229, which supports the outer peripheral surface of the rack bar 130 opposite to another outer peripheral surface of the rack bar 130 which the needle bearing 220 supports, may be formed in a semi-cylindrical shape made by cutting a part of an outer peripheral surface thereof.

The rack bushing 229 supports the rack bar 130 toward the needle bearing 220 in the radial direction of the rack bushing 229 when the rack bar 130 slides, thereby preventing the rack bar 130 from rotating.

The rack bushing 229 may have a curved surface identical to or corresponding to the outer peripheral surface of the rack bar 130 so as to be closely contacted with and supported on the outer peripheral surface of the rack bar 130.

A bushing coupling groove 166-1, to which the rack bushing 229 is coupled, may be formed on an inner peripheral surface of the rack housing 160.

The rack bushing 229 may have a fixing protrusion 229a formed on or around an end portion of an outer peripheral surface of the rack bushing 229 in order to prevent the axial position of the rack bushing 229 from being separated or rotated when the rack bar 130 slides.

A fixing groove 166-2 may be formed on the inner peripheral surface of the rack housing 160, and the fixing protrusion 229a of the rack bushing 229 may be coupled to the fixing groove 166-2 of the rack housing 160.

The rack bushing 229 may have predetermined rigidity and elasticity and made of one or more materials selected from a group consisting of polyacetal (POM), polyamide (PA), polycarbonate (PC), polyimide (PI), polybutylene terephthalate (PBT), polyphenylene sulfide (PPS), and phenol formaldehyde (PF).

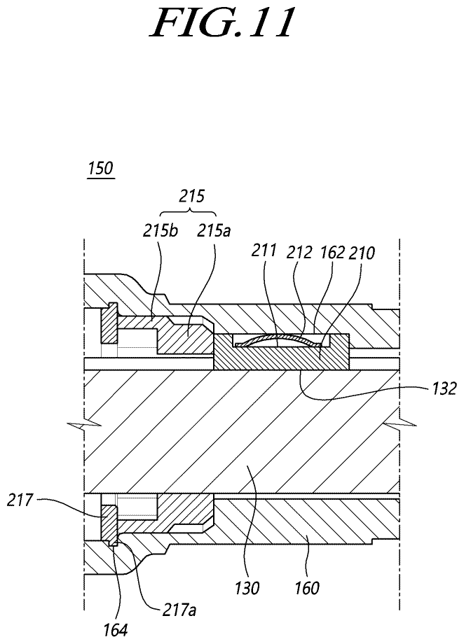

In an embodiment illustrated in FIG. 11, the rotation prevention member 150 may be configured to prevent the rack bar 130 from rotating about the central axis of the rack bar 130. The rotation prevention member 150 supports the outer peripheral surface of the rack bar 130 and may be supported on the inner peripheral surface of the rack housing 160.

The rotation prevention member 150 may include a support member 210 having one end portion disposed or supported in a rack support groove 132 formed on the outer peripheral surface of the rack bar 130, and the other end portion disposed or supported in a housing groove 162 formed on the inner peripheral surface of the rack housing 160, and an elastic member 212 coupled to the support member 210 and configured to elastically support the inner peripheral surface of the rack housing 160.

The rack support groove 132 formed on the outer peripheral surface of the rack bar 130 may be formed by machining or grinding the outer peripheral surface of the rack bar 130.

The rack support groove 132 may be recessed from the outer peripheral surface of the rack bar 130. The rack support groove 132 may have a curved surface or a flat surface.

The rack support groove 132 may be elongated in the axial direction of the rack bar 130 and be supported by the support member 210 when the rack bar 130 slides in the axial direction of the rack bar 130.

A coating layer may be provided on the rack support groove 132 and made of a low-friction material, such as fluorine resin or ceramic, in order to reduce or minimize friction with the support member 210.

The housing groove 162, in which the other end portion of the support member 210 is supported, may be formed at a position facing the rack support groove 132 in the radial direction of the rack bar 130.

For example, the housing groove 162 may be formed by machining or grinding the inner peripheral surface of the rack housing 160.

The housing groove 162 may be recessed from the inner peripheral surface of the rack housing 160 and have a curved surface or a flat surface so that the support member 210 can prevents the rotation of the rack bar 130 when the rack bar 130 slides in the axial direction of the rack bar 130.

One end portion and the other end portion of the support member 210 are coupled to the rack support groove 132 and the housing groove 162, respectively, and a coupling groove 211, to which the elastic member 212 is coupled, is formed at the other end portion of the support member 210.

The support member 210 may have predetermined rigidity and elasticity and be made of one or more materials selected from a group consisting of polyacetal (POM), polyamide (PA), polycarbonate (PC), polyimide (PI), polybutylene terephthalate (PBT), polyphenylene sulfide (PPS), and phenol formaldehyde (PF).

The elastic member 212 is coupled to the coupling groove 211 of the support member 210, supports the support member 210 and is configured to apply elastic force toward the rack bar 130 while being elastically supported on the inner peripheral surface of the rack housing 160, such that the support member 210 maintains a predetermined interval so as not to collide with the inner peripheral surface of the rack housing 160 when the rack bar 130 slides in the axial direction of the rack bar 130. Therefore, rattle noise between the support member 210 and the rack housing 160 may be prevented.

For example, the elastic member 212 may be formed as an arcuate thin board.

A plug bolt 215 may be disposed at an axial end of the support member 210, may be configured to prevent the separation of the support member 210, and may be coupled to the inner peripheral surface of the rack housing 160. For instance, the plug bolt 215 may be press-fitted and coupled to the inner peripheral surface of the rack housing 160.

The plug bolt 215 includes a support portion 215a configured to support the support member 210 in the axial direction of the rack bar 130, and a fixing portion 215b extended from the support portion 215a and fixed to the inner peripheral surface of the rack housing 160.

The outer peripheral surface of the fixing portion 215b has a threaded portion screw-coupled to the inner peripheral surface of the rack housing 160.

Further, a fixing member 217 may be coupled to an axial end of the plug bolt 215 in order to prevent the plug bolt 215 from being loosened and separated.

A fixing protrusion 217a protruding in the radial direction of the rack housing 160 may project from an outer peripheral surface of the fixing member 217.

A fixing groove 164 may be formed on the inner peripheral surface of the rack housing 160, and the fixing protrusion 217a of the fixing member 217 may be inserted into and supported by the fixing groove 164.

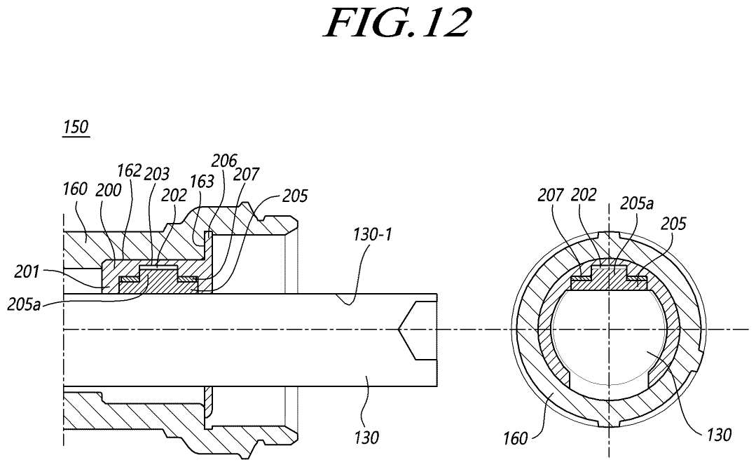

In an embodiment of FIG. 12, the rotation prevention member 150 may be supported on the outer peripheral surface of the rack bar 130 and the inner peripheral surface of the rack housing and prevent the rack bar 130 from rotating about the central axis.

The rotation prevention member 150 may include a support bushing 205 configured to support the support surface 130-1 formed on the outer peripheral surface of the rack bar 130, a bushing holder 200 coupled to the outer peripheral surface of the rack bar 130 and having an inner peripheral surface on which the support bushing 205 is supported, and an elastic member 207 coupled between the bushing holder 200 and the support bushing 205 and configured to elastically support the support bushing 205 by apply elastic force toward the rack bar 130.

For example, the support surface 130-1 formed on the outer peripheral surface of the rack bar 130 may be formed by machining or grinding the outer peripheral surface of the rack bar 130.

The support surface 130-1 may be recessed from the outer peripheral surface of the rack bar 130 and may have a curved surface or a flat surface.

The support surface 130-1 is elongated in the axial direction of the rack bar 130 and is supported by the support bushing 205 when the rack bar 130 slides in the axial direction.

A coating layer may be provided on the support surface 130-1 and made of a low-friction material, such as fluorine resin or ceramic, in order to minimize or reduce friction with the support bushing 205.

The housing groove 162, to and in which the bushing holder 200 is coupled and supported, is formed on the inner peripheral surface of the rack housing 160, and is positioned to face the support surface 130-1 in the radial direction of the rack bar 130.

For example, the housing groove 162 may be formed by machining or grinding the inner peripheral surface of the rack housing 160.

The housing groove 162 may be recessed from the inner peripheral surface of the rack housing 160 and may have a curved surface or a flat surface.

In addition, a stepped projection portion 163 having a larger diameter at an end portion of the housing groove 162 may be formed on the inner peripheral surface of the rack housing 160, and an end portion of the stepped projection portion 163 may have an opening in the axial direction of the rack bar 130.

The bushing holder 200 has a cylindrical shape. For instance, the bushing holder 200 may have a cut-out portion made by cutting one radial side of the bushing holder 200, and an inner peripheral protruding surface 201 which protrudes radially inward.

Further, a bushing coupling groove 203, to which the support bushing 205 is coupled, may be formed on the inner peripheral protruding surface 201. A flange portion 206 protrudes in the radial direction, is supported by or on the stepped projection portion 163 of the rack housing 160, and may be formed at an axial end of the bushing holder 200.

The flange portion 206 is supported by or on the stepped projection portion 163 to prevent the separation of the bushing holder 200 when the rack bar 130 slides in the axial direction.

The support bushing 205 coupled to the bushing coupling groove 203 of the bushing holder 200 includes a protruding support portion 205a protruding from a central portion of the support bushing 205, and the elastic member 207 is coupled to the protruding support portion 205a.

For example, the elastic member 207 may be formed in an annular shape and formed in a cone shape in which an inner peripheral surface and an outer peripheral surface of the elastic member 207 are stepped in the axial direction such that the protruding support portion 205a may be coupled to an inner peripheral surface of the elastic member 207.

The elastic member 207 elastically supports the support bushing 205 to apply elastic force toward the rack bar 130 and the elastic member 207 may be positioned between the bushing holder 200 and the support bushing 205, thereby forming a gap or space 202 so that the support bushing 205 cannot collide with the bushing holder 200 when the rack bar 130 slides in the axial direction to prevent or reduce rattle noise between the support bushing 205 and the bushing holder 200.

The bushing holder 200 and the support bushing 205 may have predetermined rigidity and elasticity and made of one or more materials selected from a group consisting of polyacetal (POM), polyamide (PA), polycarbonate (PC), polyimide (PI), polybutylene terephthalate (PBT), polyphenylene sulfide (PPS), and phenol formaldehyde (PF).

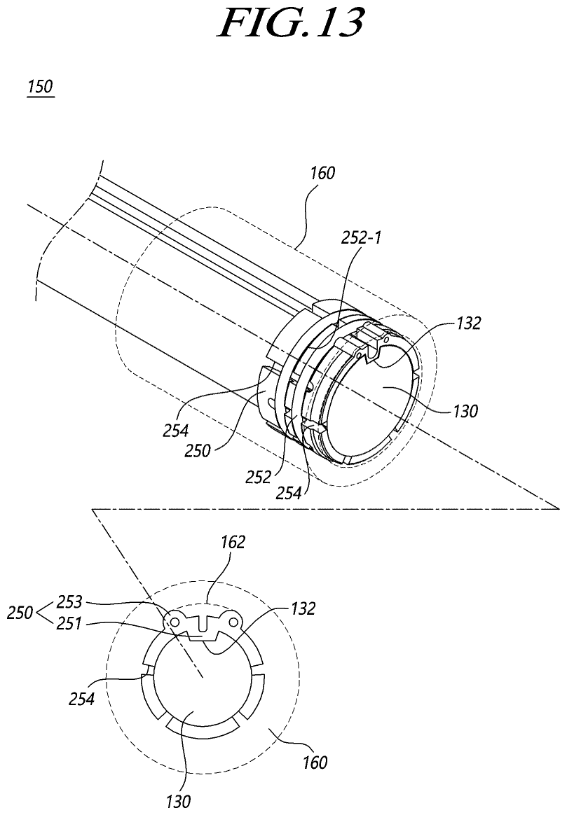

In an embodiment of FIG. 13, the rotation prevention member 150 may support the outer peripheral surface of the rack bar 130 to prevent the rack bar 130 from rotating about the central axis of the rotation prevention member 150 and may be supported by the inner peripheral surface of the rack housing 160.

The rotation prevention member 150 may include a rack bushing 250 having an inner peripheral support portion 251 inserted in and supported by the rack support groove 132 formed on the outer peripheral surface of the rack bar 130 and an outer peripheral support portion 253 inserted in and supported by the housing groove 162 formed on the inner peripheral surface of the rack housing 160, and an elastic member 252 coupled to the outer peripheral surface of the rack bushing 250 and configured to elastically support the rack bushing 250.

For example, the rack support groove 132 formed on the outer peripheral surface of the rack bar 130 may be formed by machining or grinding the outer peripheral surface of the rack bar 130.

The rack support groove 132 may be recessed from the outer peripheral surface of the rack bar 130 and may have a curved surface or a flat surface.

The rack support groove 132 is elongated in the axial direction of the rack bar 130 so as to be supported by the rack bushing 250 when the rack bar 130 slides in the axial direction.

A coating layer may be provided on the rack support groove 132 and made of a low-friction material, such as fluorine resin or ceramic, in order to minimize or reduce friction with the rack bushing 250.

The inner peripheral support portion 251 protrudes radially inward from the inner peripheral surface of the rack bushing 250 at a position facing the rack support groove 132.

The outer peripheral support portion 253 protrudes radially outward from the outer peripheral surface of the rack bushing 250 and is coupled to the housing groove 162.

For instance, the housing groove 162 may be formed by machining or grinding the inner peripheral surface of the rack housing 160.

The housing groove 162 may be recessed from the inner peripheral surface of the rack housing 160 and may have a curved surface or a flat surface.

Two or more outer peripheral support portions 253 may be formed on the outer peripheral surface of the rack bushing 250 and spaced apart from one another in a circumferential direction.

For instance, a pair of outer peripheral support portions 253 may be formed on the outer peripheral surface of the rack bushing 250 in the circumferential direction at a position corresponding to the inner peripheral support portion 251.

The rack bushing 250 may have predetermined rigidity and elasticity and be made of one or more materials selected from a group consisting of polyacetal (POM), polyamide (PA), polycarbonate (PC), polyimide (PI), polybutylene terephthalate (PBT), polyphenylene sulfide (PPS), and phenol formaldehyde (PF).

The elastic member 252 may be coupled to the outer peripheral surface of the rack bushing 250 and have a ring shape.

The elastic member 252 may be made of a material capable of absorbing vibration and noise and have predetermined elasticity and rigidity. Therefore, the elastic member 252 may be made of one or more materials selected from a group consisting of natural rubber (NR), nitrile butadiene rubber (NBR), chloroprene rubber (CR), ethylene propylene terpolymer (EPDM), fluoro-rubber (FPM), styrene butadiene rubber (SBR), chlorosulfonated polyethylene (CSM), urethane, and silicone that have the above-mentioned properties.

A coupling groove 252-1, to which the elastic member 252 is coupled, may be formed on the outer peripheral surface of the rack bushing 250.

The rack bushing 250 may have a cut-out portion 254 cut in the axial direction so that the rack bushing 250 is deformable in the radial direction.

Two or more cut-out portions 254 spaced apart from one another in the circumferential direction may be provided.

The cut-out portions 254 may be formed such that one end or the other end of the rack bushing 250 is opened at a position wherein the cut-out portion 254 is formed.

The cut-out portions 254 opened at one end of the rack bushing 250 and the cut-out portion 254 opened at the other end of the rack bushing 250 may be spaced apart from each other in the circumferential direction and formed in a staggered manner.

Therefore, the rack bushing 250 is elastically supported in the radial direction by elastic force of the elastic member 252 so that the rack bushing 250 cannot collide with the rack housing 160 when the rack bar 130 slides in the axial direction to prevent or reduce rattle noise between the rack bushing 250 and the rack housing 160.

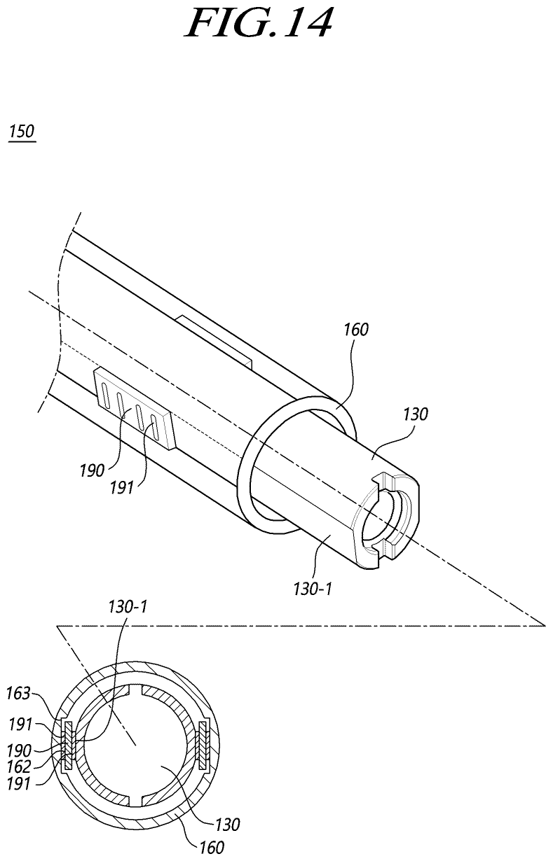

In an embodiment illustrated in FIG. 14, the rotation prevention member 150 may support the outer peripheral surface of the rack bar 130 to prevent the rack bar 130 from rotating about the central axis of the rack bar 130 and may be supported by the inner peripheral surface of the rack housing 160.

The rotation prevention member 150 may include a rotary member 191 configured to support the support surface 130-1 formed on the outer peripheral surface of the rack bar 130, and a support bushing 190 coupled to the housing groove 162 formed on the inner peripheral surface of the rack housing 160 and configured such that the rotary member 191 is rotatably coupled to the support bushing 190.

For instance, the support surface 130-1 formed on the outer peripheral surface of the rack bar 130 may be formed by machining or grinding the outer peripheral surface of the rack bar 130.

The support surface 130-1 may be recessed from the outer peripheral surface of the rack bar 130 and have a curved surface or a flat surface.

The support surface 130-1 is elongated in the axial direction of the rack bar 130 so as to be supported by the rotary member 191 when the rack bar 130 slides in the axial direction.

Two or more support surfaces 130-1 may be formed on the outer peripheral surface of the rack bar 130 and spaced apart from one another in the circumferential direction of the rack bar 130.

For instance, a pair of support surfaces 130-1 may formed at opposite sides of the rack bar 130 with respect to the center of the rack bar 130.

The rotary members 191 may be configured as a roller or ball movably disposed in an inner surface of the support bushing 190 (e.g. within one or more elongated holes of the support bushing 190) and configured to be rotatable or rollable while being supported on the support surface 130-1 of the rack bar 130.

The rotary members 191 may be rotatably supported on both the inner and outer surfaces of the support bushing 190.

A coating layer may be provided on the support surface 130-1 and made of a low-friction material, such as fluorine resin or ceramic, in order to reduce or minimize friction with the rotary member 191.

The housing groove 162, in which the support bushing 190 is disposed, is formed on the inner peripheral surface of the rack housing 160 at a position facing a support surface 130-1 of the rotary member 191 in the radial direction.

The support bushing 190 is coupled to the housing groove 162 of the rack housing 160, and the rotary member 191 is rotatably coupled to the support bushing 190.

The support bushing 190 may have predetermined rigidity and elasticity and made of one or more materials selected from a group consisting of polyacetal (POM), polyamide (PA), polycarbonate (PC), polyimide (PI), polybutylene terephthalate (PBT), polyphenylene sulfide (PPS), and phenol formaldehyde (PF).

For instance, the housing groove 162 may be formed by machining or grinding the inner peripheral surface of the rack housing 160.

The housing groove 162 may be recessed from the inner peripheral surface of the rack housing 160 and may have a curved surface or a flat surface.

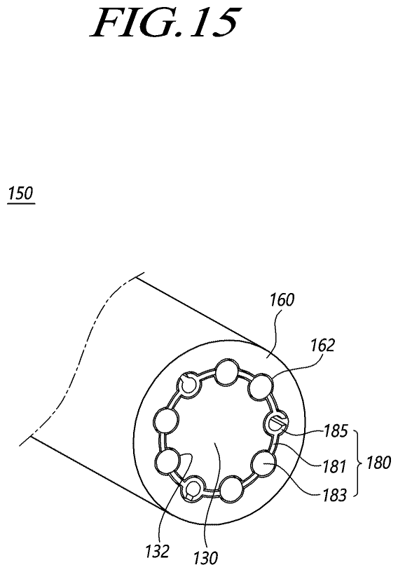

In an embodiment illustrated in FIG. 15, the rotation prevention member 150 may support the outer peripheral surface of the rack bar 130 to prevent the rack bar 130 from rotating about the central axis and is supported by the inner peripheral surface of the rack housing.

The rotation prevention member 150 may include a rack bushing 180 having one or more rotation support portions 183 rotatably disposed between the rack support groove 132 formed on the outer peripheral surface of the rack bar 130 and the housing groove 162 formed on the inner peripheral surface of the rack housing 160, an elastic support portion 185 disposed between and elastically supported by the rack support groove 132 formed on the outer peripheral surface of the rack bar 130 and the housing groove 162 formed on the inner peripheral surface of the rack housing 160, and a connection portion 181 connecting the rotation support portion 183 and the elastic support portion 185.

The rack support groove 132 may be formed on the outer peripheral surface of the rack bar 130. For instance, the rack support groove 132 may be formed by machining or grinding the outer peripheral surface of the rack bar 130.

The rack support groove 132 may be recessed from the outer peripheral surface of the rack bar 130, and include a curved surface or a flat surface.

The rack support groove 132 is elongated in the axial direction of the rack bar 130 and is supported by the rotation support portion 183 and the elastic support portion 185 when the rack bar 130 slides in the axial direction. The rotation support portion 183 and the elastic support portion 185 may be disposed in the rack support groove 132.

The housing groove 162 is formed on the inner peripheral surface of the rack housing 160 at the position facing or corresponding to the rack support groove 132 in the radial direction.

For instance, the housing groove 162 may be formed by machining or grinding the inner peripheral surface of the rack housing 160.

The housing groove 162 may be recessed from the inner peripheral surface of the rack housing 160 and may have a curved surface or a flat surface.

A coating layer may be provided on the rack support groove 132 and the housing groove 162 and made of a low-friction material, such as fluorine resin or ceramic, in order to minimize or reduce friction with the rack bushing 180.

The rack bushing 180 may have two or more rotation support portions 183 and/or two or more elastic support portions 185.

Balls may be coupled to the rotation support portions 183, and the balls may be spaced apart from one another in the axial direction.

The elastic support portion 185 may have a substantially cylindrical shape. The elastic support portion 185 may have an opening at one side thereof.

The rack bushing 180 is elastically supported by the rack support groove 132 and the housing groove 162 by an elastic deformation force of the elastic support portion 185, thereby maintaining a predetermined interval so that the rack bushing 180 does not collide with the rack housing 160 when the rack bar 130 slides in the axial direction to prevent rattle noise between the rack bushing 180 and the rack housing 160.

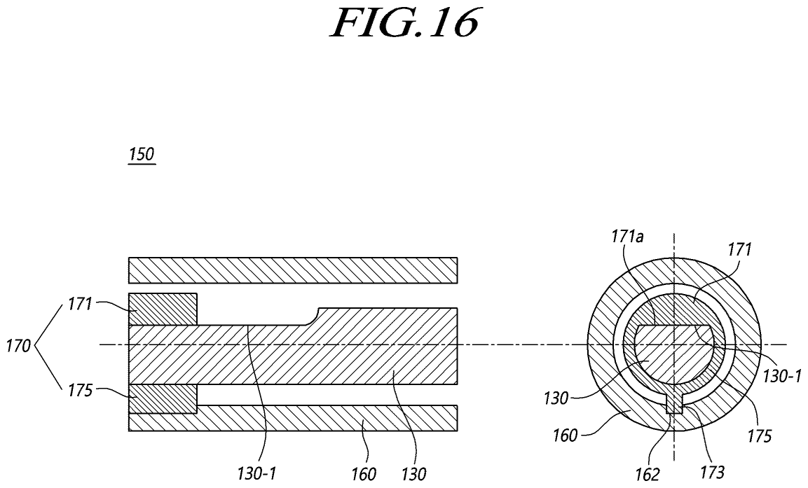

In an embodiment illustrated in FIG. 16, the rotation prevention member 150 may support the outer peripheral surface of the rack bar 130 to prevent the rack bar 130 from rotating about the central axis and the rotation prevention member 150 may be supported by the inner peripheral surface of the rack housing 160.

The rotation prevention member 150 may include a rack bushing 170 having a first support portion 171 and a second support portion 175. The first support portion 171 may be configured to support the support surface 130-1 formed on the outer peripheral surface of the rack bar 130. The second support portion 175 may be extended from or connected to the first support portion 171, may be configured to support the outer peripheral surface of the rack bar 130, and may have an outer peripheral surface on which a fixing protrusion 173, which is coupled to the housing groove 162 formed on the inner peripheral surface of the rack housing 160.

For example, the support surface 130-1 formed on a part of the outer peripheral surface of the rack bar 130 may be formed by machining or grinding the outer peripheral surface of the rack bar 130.

The support surface 130-1 may be recessed from the outer peripheral surface of the rack bar 130 and may have a curved surface or a flat surface.

The support surface 130-1 is elongated in the axial direction of the rack bar 130 so as to be supported by the first support portion 171 when the rack bar 130 slides in the axial direction.

An inner peripheral surface 171a of the first support portion 171 may be closely contacted with and supported by the support surface 130-1 of the rack bar 130, and an outer peripheral surface of the first support portion 171 may be spaced apart from the inner peripheral surface of the rack housing 160.

A coating layer may be provided on the support surface 130-1 and the outer peripheral surface of the rack bar 130 and made of a low-friction material, such as fluorine resin or ceramic, in order to minimize or reduce friction with the rack bushing 170.

The second support portion 175 is extended from or connected to the first support portion 171 in the circumferential direction and surrounds the outer peripheral surface of the rack bar 130.

The fixing protrusion 173 protrudes from the outer peripheral surface of the second support portion 175 in the radial direction.

The housing groove 162 may be formed on the inner peripheral surface of the rack housing 160, and the fixing protrusion 173 of the second support portion 175 may be inserted in or coupled to the housing groove 162, thereby preventing the rack bushing 170 from rotating. For example, the housing groove 162 may be formed by machining or grinding the inner peripheral surface of the rack housing 160.

The housing groove 162 may be recessed from the inner peripheral surface of the rack housing 160 and may have a curved surface or a flat surface.

The rack bushing 170 may have predetermined rigidity and elasticity and made of one or more materials selected from a group consisting of polyacetal (POM), polyamide (PA), polycarbonate (PC), polyimide (PI), polybutylene terephthalate (PBT), polyphenylene sulfide (PPS), and phenol formaldehyde (PF).

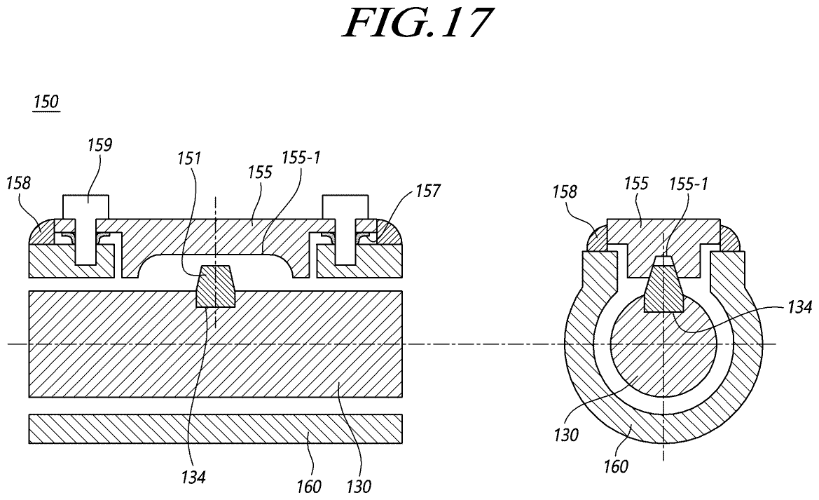

In an embodiment illustrated in FIG. 17, the rotation prevention member 150 may be supported by a guide cover 155, which is coupled to the rack housing 160, and may support the outer peripheral surface of the rack bar 130 to prevent the rack bar 130 from rotating about the central axis.

The rotation prevention member 150 may include a support member 151 coupled to the outer peripheral surface of the rack bar 130, the guide cover 155 coupled to the rack housing 160 and having an inner peripheral surface which the support member 151 supports, and a fastener 159 configured to fix the guide cover 155 to the rack housing 160.

The support member 151 may be coupled to the outer peripheral surface of the rack bar 130. For instance, the support member 151 may be coupled, by press-fitting, bonding, or the like, to a coupling groove 134 formed on the outer peripheral surface of the rack bar 130. The coupling groove 134 may be formed by machining or grinding the outer peripheral surface of the rack bar 130.

The coupling groove 134 may be recessed from the outer peripheral surface of the rack bar 130 and may have a curved surface or a flat surface.

The rack housing 160 may have an opening at a position facing or corresponding to the support member 151, and the guide cover 155 is coupled to and covers the opening of the rack housing 160.

The inner peripheral surface of the guide cover 155 may have a support groove 155-1 into and by which the support member 151 is inserted and supported.

The support groove 155-1 of the guide cover 155 is elongated in the axial direction of the rack bar 130 so that the support member 151 may be supported by the support groove 155-1 when the rack bar 130 slides in the axial direction.

The support groove 155-1 may have, for example, but not limited to, a trapezoidal shape having a width that increases toward the support member 151.

The support member 151 may have a trapezoidal shape having a width that decreases from the outer peripheral surface of the rack bar 130 toward the support groove 155-1.

Two opposite side surfaces of the support groove 155-1 may be closely contacted with and supported by the support member 151, and an inner top surface of the support groove 155-1 positioned between the two opposite side surfaces of the support groove 155-1 may be spaced apart from an end of the support member 151.

A coating layer may be provided on the support groove 155-1 or the support member 151 and made of a low-friction material, such as fluorine resin or ceramic, in order to reduce or minimize friction.

The support groove 155-1 may have grease therein in order to minimize friction with the support member 151.

The guide cover 155 may be fixed to the rack housing 160 by the fastener 159.

Further, an elastic member 157 may be disposed between the guide cover 155 and the rack housing 160, penetrated by the fastener 159, and configured to elastically support the guide cover 155 and the rack housing 160.

A sealing member or seal 158 may be applied onto the ends of the guide cover 155 and the outer peripheral surface of the rack housing 160 in order to prevent moisture or dust from being introduced from the outside of the rack housing 160.

The support member 151 and the guide cover 155 may have predetermined rigidity and elasticity and made of one or more materials selected from a group consisting of polyacetal (POM), polyamide (PA), polycarbonate (PC), polyimide (PI), polybutylene terephthalate (PBT), polyphenylene sulfide (PPS), and phenol formaldehyde (PF).

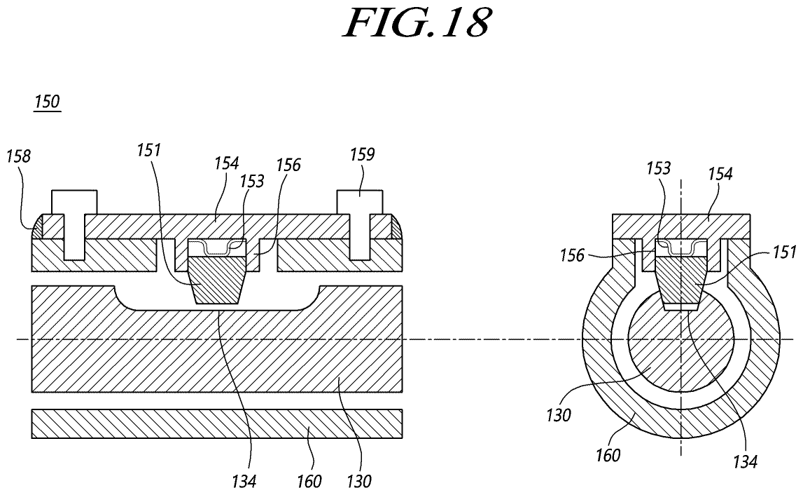

In an embodiment illustrated in FIG. 18, the rotation prevention member 150 may be supported by a housing cover 154, which is coupled to the rack housing 160, and the outer peripheral surface of the rack bar 130, thereby preventing the rack bar 130 from rotating about the central axis of the rack bar 130.

The rotation prevention member 150 may include the support member 151 supporting the outer peripheral surface of the rack bar 130, the housing cover 154 fixed to the rack housing 160 and having the inner peripheral surface to which the support member 151 is coupled, and the fastener 159 configured to fix the housing cover 154 to the rack housing 160.

A rack support groove 134 by which the support member 151 is supported is formed on the outer peripheral surface of the rack bar 130.

The rack support groove 134 is elongated or extended in the axial direction of the rack bar 130 so that the support member 151 may be supported by the rack support groove 134 when the rack bar 130 slides in the axial direction.

The rack support groove 134 may be recessed from the outer peripheral surface of the rack bar 130 and may have a curved surface or a flat surface.

The rack housing 160 may have an opening a position corresponding to or facing the rack support groove 134, and the housing cover 154 is coupled to the opening of the rack housing 160.

A cover support groove 156, in which the support member 151 is positioned, may be formed on the inner peripheral surface of the housing cover 154.

The rack support groove 134 may have, for example, but not limited to, a trapezoidal shape with a width that increases toward the housing cover 154.

The support member 151 may have a trapezoidal shape with a width that decreases from the cover support groove 156 toward the rack support groove 134.

Two opposite side surfaces of the rack support groove 134 may be closely contacted with and supported by the support member 151, and an inner surface of the rack support groove 134 positioned between the two opposite side surfaces of the rack support groove 134 may be spaced apart from the end of the support member 151.

A coating layer may be provided on the rack support groove 134 or the support member 151 and made of a low-friction material, such as fluorine resin or ceramic, in order to reduce or minimize friction.

The rack support groove 134 may be provided or filled with grease in order to reduce or minimize friction with the support member 151.

The housing cover 154 may be fixed to the rack housing 160 by the fastener 159.

The seal or sealing member 158 may be applied onto the end portion of the housing cover 154 and the outer peripheral surface of the rack housing 160 in order to prevent moisture or dust from being introduced from the outside of the rack housing 160.

The support member 151 and the housing cover 154 may have predetermined rigidity and elasticity and made of one or more materials selected from a group consisting of polyacetal (POM), polyamide (PA), polycarbonate (PC), polyimide (PI), polybutylene terephthalate (PBT), polyphenylene sulfide (PPS), and phenol formaldehyde (PF).

As described above, a steer-by-wire steering apparatus according to some embodiments of the present disclosure may have the plurality of motors and provide a steering force to a rack bar. In addition, a steer-by-wire steering apparatus according to some embodiments of the present disclosure may prevent unnecessary rotation of a rack bar even though means for preventing the rotation of the rack bar is provided and the pinion is excluded.

Hereinafter, various embodiments related to a method of determining the position of a rack bar in a steer-by-wire steering apparatus will be described. Some embodiments of the method of determining the position of the rack bar described below may be applied regardless of the above-mentioned configuration, position and shape of the motor. However, certain embodiments of the method of determining the position of the rack bar may be applied to the above-mentioned configuration, position and shape of the motor. In addition, the method of determining the position of the rack bar may be applied in exemplary embodiments of the steer-by-wire steering apparatus not including the rotation prevention member or may be applied in any type of a rotation prevention member.

In the steer-by-wire steering apparatus, the electronic control device 110 may control the operations of one or more drive motors (e.g., 145 and 147). For instance, the electronic control device 110 may receive information or one or more signals from one or more sensors associated with the vehicle and control one or more drive motors based on the information or signals received from one or more sensors.

One or more sensors include various sensors, such as a steering angle sensor, a steering torque sensor, a vehicle speed sensor, a rack position sensor, and any type of a sensor mounted to or provided in the vehicle in association with the steering of the vehicle. However, as described above, according to some embodiments of the present disclosure, the pinion may not be included in the steer-by-wire steering apparatus in case that the rack bar is configured to be moved by the first motor and the second motor. In this case, the rack position sensor configured to detect an absolute position of the rack bar may not be included in the steer-by-wire steering apparatus. Alternatively, the rack position sensor configured to detect the absolute position of the rack bar may be included in a gearbox configured to connect the first and/or second motors to the rack bar.

First, various embodiments for identifying the absolute position (or an absolute angle) of the rack bar will be described. Thereafter, an embodiment comprising an absolute angle sensor configured to detect the absolute position (or an absolute angle) of the rack bar will be described.

The electronic control device 110 may control an operation of the steering shaft motor 120. The electronic control device 110 may be configured as one chip integrated physically. Alternatively, the electronic control device 110 may be configured by a plurality of chips. For instance, each of a reaction force motor, a drive motor, a main control unit, and any component of the steer-by-wire steering apparatus includes one or more chips to perform their necessary operations.

Meanwhile, the electronic control device 110 may control a traveling direction of the vehicle in accordance with the driver's steering intention by controlling the operations of the plurality of drive motors (e.g., 145 and 147).

Multiple electronic control devices 110 may be provided in the steer-by-wire steering apparatus in order to ensure redundancy and constantly or stably perform the same operation even in a case that any one of the plurality of the electronic control devices 110 is abnormal or inoperable. Alternatively, the multiple electronic control devices 110 includes a main electronic control device and a sub-electronic control device. The main electronic control device may control the operation of the steer-by-wire steering apparatus if the main electronic control device is in a normal state, and the sub-electronic control device may control the operation of the steer-by-wire steering apparatus if the main electronic control device is abnormal or inoperable.

The electronic control device 110 may control the steering of the vehicle in response to various information. The steer-by-wire (SBW) system may need accurate information regarding a position of the rack bar to accurately control the steering of the vehicle especially in case that the plurality of motors is used to control the rack bar.

To this end, the electronic control device 110 may receive the position information of the rack bar from the rack position sensor. Alternatively, the electronic control device 110 may estimate the position of the rack bar by using positions of the plurality of motors without the rack position sensor.

For example, the electronic control device 110 may receive rotation information of each of the motors from the plurality of motor position sensors. In an exemplary embodiment of the present disclosure, the rotation information of the motor may include rotation information of the first motor and rotation information of the second motor. The rotation information of the first motor may be received from a first motor position sensor included in or associated with the first motor. The rotation information of the second motor may be received from a second motor position sensor included in or associated with the second motor.

The motor position sensor may detect rotation information of each of the motors. The motor position sensor may detect a rotation of a motor shaft. Alternatively, the motor position sensor may detect a rotation of any rotatable component or structure connected to or associated with the motor shaft. The motor position sensor may detect a rotary position between 0 degree and 360 degrees related to the rotation of the motor. For instance, the motor position sensor may measure a rotation angle and/or a position of the motor.

For example, the motor position sensor may be an optical sensor or encoder configured to detect a position by emitting light to a rotary plate or disk. Alternatively, the motor position sensor may be a magnetic sensor or encoder configured to measure a position of a rotor by detecting a magnetic field. Alternatively, the motor position sensor may be an incremental sensor or encoder configured to measure a change in a relative position of a rotor by outputting a predetermined pulse. Alternatively, the motor position sensor may be an absolute sensor or encoder configured to measure an absolute position of a rotor by outputting a unique value related to a particular position. The motor position sensor according to certain embodiments of the present disclosure may provide a precise position and/or velocity of the motor.

For instance, a Hall sensor, which measures a position of a motor by detecting a change in magnetic flux of a rotor to which a permanent magnet or magnetic material is attached or mounted, may be used as the motor position sensor. The motor of the steer-by-wire steering apparatus may be a Brushless Direct Current (BLDC) motor, and three Hall sensors having a phase difference of 120 degrees or 60 degrees may be arranged or disposed to detect the position of the motor. In addition, the motor position sensor may be a resolver configured to measure a position in an analog manner by using a change in voltage or an inductive position sensor configured to detect a position by using an electromagnetic induction principle. In the present disclosure, any type of sensors may be used as the motor position sensor.

The motor position sensor may measure an absolute position or an absolute angle value based on a particular position of the motor. Alternatively, the motor position sensor may detect a relative position with respect to a reference position. Alternatively, the motor position sensor may measure an electrical position of a rotor in a BLDC or Permanent Magnet Synchronous Motor (PMSM) motor.

A rotation angle in a single turn is a rotation angle between 0 degree and 360 degrees, and therefore a rotation angle can be represented in a single rotation turn only. Therefore, the absolute position of the motor which is over 360 degrees may not be identified because an angle of the rotor of the motor is reset after one full rotation turn. However, there is an absolute motor position sensor which can measure a position of the motor in multiple turns, but it has a complicated configuration and structure and a higher price.

Without using an absolute motor position sensor, some embodiments of the present disclosure may acquire an absolute position of the rack bar by using at least two motor position sensors which measure a relative position.

For example, when two motors move a same rack bar and have different rotational velocities, rotation angles measured by two motor position sensors of two motors, respectively, may be between 0 degree and 360 degrees. If the motor position sensor is not an absolute angle sensor, an angle measured by the motor position sensor is not recorded or stored, and a rotation angle detected by a motor position sensor of the first motor may be between 0 degree and 360 degrees and a rotation angle detected by a motor position sensor of the second motor may be between 0 degree and 360 degrees.

The electronic control device 110 may receive the rotation angle detected by the motor position sensor of the first motor and the rotation angle detected by the motor position sensor of the second motor. The electronic control device 110 estimates the absolute position of the rack bar by using two rotation angles (i.e., motor positions) detected by each of two motor positions sensors of two motors.

As described above, in certain embodiments of the present disclosure, the first motor and the second motor are operably connected to a single ball nut operably coupled to the rack bar and move the rack bar at different rotational velocities. Therefore, even though the first motor and the second motor rotate at different rotational velocities, the first motor and the second motor need to rotate the ball nut at the same velocity. Therefore, the motor pulley of the first motor and the motor pulley of the second motor may be configured by different in gear ratio.

The gear ratio may refer to, for example, but not limited to, a ratio of the numbers of threads or diameters of pulleys. For instance, the gear ratio may be a ratio between the number of threads or a diameter of a motor pulley connected to a motor shaft of the first motor and the number of threads or a diameter of a motor pulley connected to a motor shaft of the second motor. There may be a substantial difference in gear ratio in case that the diameters of the motor pulleys are different.

The first motor and the second motor may rotate at different rotational velocities, and the electronic control device 110 may receive different motor rotation information from the motor position sensors of the first and second motors.

The electronic control device 110 may determine the absolute position of the rack bar by using preset information and motor rotation information of the first and second motors. For example, the electronic control device 110 may calculate the absolute position of the rack bar by inputting motor rotation information of each motor into a preset Vernier algorithm.

For example, a difference in rotational velocity between the two motors may vary depending on the absolute position of the rack bar.

For example, the electronic control device 110 may determine the absolute position of the rack bar by monitoring a change in the rotation information of the two motors. For example, the electronic control device 110 may determine the position of the rack bar by using Equation 1.

$$R = \frac{K}{360} \times θ + K \times n \qquad [ Equation 1 ]$$

R represents a linear position of the rack bar, θ represents a phase difference between first rotation information of the first motor and second rotation information of the second motor, K represents a distance by which the rack bar is moved while a phase difference between the first rotation information and the second rotation information changes from 0 and a next phase difference becomes 0 in case that the rack bar moves in one direction, and n represents the number of times the phase difference becomes 0 while the rack bar moves in one direction.

That is, the electronic control device 110 may cumulatively identify the position of the rack bar by consistently monitoring the phase difference between the first rotation information of the first motor and the second rotation information of the second motor and recording the number of times the phase difference becomes 0.

In another example, the electronic control device 110 may determine the position of the rack bar based on a preset reference value. A movable range of the rack bar is structurally limited. Therefore, the plurality of positions of the rack bar corresponding to the first rotation information of the first motor and the second rotation information of the second motor can be calculated in advance and stored in the form of a table or other data formats in memory of the electronic control device 110.

When the first rotation information of the first motor and the second rotation information of the second motor are received, the electronic control device 110 may estimate the absolute position of the rack bar by comparing the first rotation information of the first motor and the second rotation information of the second motor with pre-stored data. However, in this case, the first rotation information and the second rotation information need to be designed to have different values in a linearly movable range of the rack bar. Therefore, a difference in gear ratio between the first motor and the second motor needs to be set so that the first rotation information of the first motor and the second rotation information of the second motor do not overlap at or correspond to two or more absolute positions of the rack bar.

For example, the electronic control device 110 may estimate the absolute position of the rack bar by using Equation 2.

$$A = \{ ( First Rotation Information + m ) \times First Gear Ratio \} \\ B = \{ ( Second Rotation Information + m ) \times Second Gear Ratio \} \\ Rack bar position R = intersection of A and B . \qquad [ Equation 2 ]$$

Here, m is a natural number equal to or larger than 1 and equal to or smaller than a maximum movable distance of the rack bar.

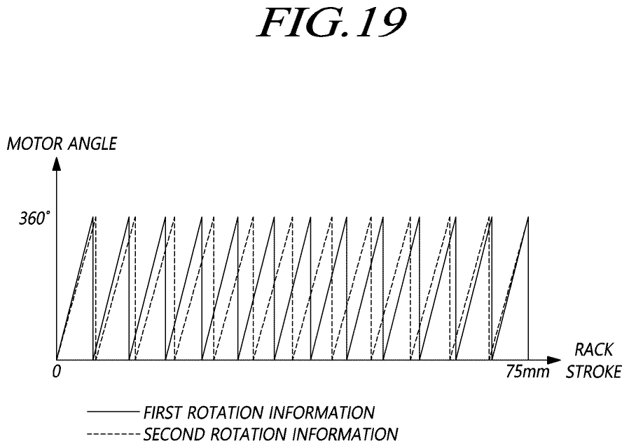

FIG. 19 is a graph for explaining a method of estimating a position of a rack bar using a difference between first rotation information of a first motor and second rotation information of a second motor. FIG. 19 illustrates relationship between the first rotation information of the first motor and the second rotation information of the second motor and a linear position of a rack bar in a movable range of the rack bar from 0 to 75 mm. As described above, the first gear ratio and the second gear ratio may be set so that the first rotation information of the first motor and the second rotation information of the second motor do not overlap or correspond to multiple positions of the rack bar.

The electronic control device 110 may include a configuration for preventing noise when estimating a precise rack bar position. For example, the electronic control device 110 may use a noise filtering technology, such as a Kalman filter, in order to reduce an error caused by noise or the like.

Therefore, without a rack position sensor, the position of the rack bar may be precisely estimated, thereby reducing manufacturing cost and improving ease of implementation.

However, a sensor assembly configured to detect the position of the rack bar may be included if necessary. For example, a sensor configured to detect the absolute position of the rack bar may detect a gear assembly connected to the ball nut operably connected to the rack bar to determine the absolute position of the rack bar. In this case, the gear assembly may be connected directly to the ball nut or connected to the nut pulley of the ball nut. Alternatively, the gear assembly may include two or more gears, and rotational velocities of the gears may decrease to an appropriate sensing level by means of a gear ratio between the gears.

Alternatively, the gear assembly may be connected to the first motor or the second motor without being connected to the ball nut or the nut pulley. Unlike an embodiment having a rack position sensor connected to a pinion gear, the rack position sensor according to another embodiment of the present disclosure may be connected to the motor or the ball nut to make a package size compact.

If any one of the motor position sensors of the motors fails, it may be difficult to determine the absolute position of the rack bar. The motor position sensor for sensing the absolute angle may be configured to ensure redundancy to prepare for this case.

Alternatively, from a fail-safe perspective, the electronic control device 110 may consistently or periodically monitor the first rotation information of the first motor and/or the second rotation information of the second motor. For example, the electronic control device 110 may determine whether the first rotation information of the first motor or the second rotation information of the second motor is out of an offset range relative to a preset value.

For instance, it is assumed that a rack stroke is 15 in case that the first rotation information of the first motor is 240 degrees and the second rotation information of the second motor is 120 degrees. The electronic control device 110 may identify the rack stroke by using preset data and using two pieces of received rotation information of the first and second motors, i.e., 240 and 120.

However, a predetermined level of offset may be applied to ensure reliability and a smooth operation of estimating the position of the rack stroke. For example, in a case that the first rotation information of the first motor is 240 and the second rotation information of the second motor is 119, the rack stroke may be estimated on the assumption that the second rotation information is 120 because a difference between the preset second rotation information of the second motor of 120 and the received second rotation information of the second motor of 119 is 1 which is smaller than a preset offset.

Therefore, the offset is determined by calculating a value allowable in the graph of FIG. 19 that varies depending on the gear ratio. For example, the offsets may be set to different values for each rack stroke or motor rotation information. Alternatively, an offset may be set to the same value for all rack stroke or motor rotation information. Therefore, a small level of error caused by noise or an error of the motor position sensor may be ignored when determining whether any one of the motor position sensors of the motors fails, thereby improving accuracy and operation responsiveness.

In still another example, the electronic control device 110 may identify a change in occurrence of error by consistently monitoring the first rotation information and the second rotation information. For example, the electronic control device 110 may monitor the first rotation information and the second rotation information, track the frequencies or occurrence of the errors of the first rotation information and the second rotation information, and identify whether the occurrence of the error increase and whether errors occur more frequently even within the offset range. In case that errors occur more frequently or the magnitude of errors increases within a predetermined time period, the electronic control device 110 may detect a risk of failure of the first and second motor position sensors of the first and second motors and output a signal for alert in advance.

Alternatively, the electronic control device 110 may recognize that the rack stroke represents movement of the rack bar in one dimension, and sudden changes in the position of the rack bar cannot occur due to physical limitations. For example, it is assumed that the rack stroke is set to 30 in case that the first rotational information of the first motor is 160 and the second rotational information of the second motor is 128, and the rack stroke is 70 when the first rotation information of the first motor is 162 and the second rotation information of the second motor is 130. In this case, when the first rotation information of the first motor of 162 and the second rotation information of the second motor of 130 are inputted after the first rotational information of the first motor of 160 and the second rotational information of the second motor of 128 are inputted, the electronic control device 110 may perform a fail-safe operation within a predetermined time period instead of determining that the rack stroke is changed from 35 to 70.

For example, the electronic control device 110 may determine the linear position of the rack bar or the rack stroke within a time window set as a predetermined time period. In case that the linear position of the rack bar or the rack stroke changes rapidly within the time window and the rapid change in the linear position of the rack bar or the rack stroke is determined to be temporary or one-time, it may be determined as noise and ignored when estimating the linear position of the rack bar or the rack stroke.

However, in case that the electronic control device 110 determines that the rack stroke has changed rapidly within the predetermined time window and the rapid change in the linear position of the rack bar or the rack stroke is determined not to be not temporary or one-time, the electronic control device 110 may determine that accident or system failure occurs. For example, when the estimated rack stroke is changed from 35 to 70 and then is changed to 37 and 38 within the preset time window, the estimated rack stroke of 70 may be determined as noise and ignored. On the contrary, when the rack stroke is significantly changed from 35 to 70, 10, and 50 within a predetermined time window, the electronic control device 110 may determine that an accident or failure occurs.

When determining the occurrence of an accident or failure, the electronic control device 110 may notify the occurrence of the accident or failure to a designated component or point (e.g. another electronic control device or an output apparatus such as a display or a warning lamp) through a communication means or a communicator.

As described above, the electronic control device may determine the absolute position of the rack bar using the motor position information of the motor driving the rack bar. In particular, according to an embodiment of the present disclosure, it is possible to accurately determine the linear position or sliding position of the rack bar without a rack position sensor, even in the steer-by-wire system configured with a high reduction ratio.

To this end, according to an embodiment of the present disclosure, a steer-by-wire system may include a ball nut, a first nut pulley, a second nut pulley, a first motor pulley, a second motor pulley, and an electronic control device. The ball nut may be configured to be rotatable and be operably coupled to a rack bar via a ball. The ball nut may configured to slide or linearly move the rack bar in an axial direction by rotation of the ball nut. The first nut pulley may be provided on an outer peripheral surface of the ball nut, and a second nut pulley may be provided on the outer peripheral surface of the ball nut. The first motor pulley may be coupled to a first motor and connected to the first nut pulley via a first belt, and the second motor pulley coupled to a second motor and connected to the second nut pulley via a second belt. The electronic control device such as a controller or processor may configured to identify or compute the linear position or sliding position of the rack bar using a first position value detected from a first motor sensor configured to detect a rotational position of a shaft of the first motor, a second position value detected from a second motor sensor configured to detect a rotational position of a shaft of the second motor, and section information.

The section information may be information about a section of the rack bar in which the rack bar is located, among a plurality of sections defined along a movable range of the rack bar. The electronic control device may identify or determine the section information of the rack bar based on a measured rack force value or a measured wheel angle information, and determine sliding position information of the rack bar or information about a linear position of the rack bar using relative sliding position information determined using the first position value and the second position value and the section information.

As described above, the first reduction ratio determined by the first motor pulley and the first nut pulley and the second reduction ratio determined by the second motor pulley and the second nut pulley may be set to different values, respectively. Alternatively, both the first reduction ratio and the second reduction ratio may be set to the same value.

In a steer-by-wire system according to an embodiment of the present disclosure, a power pack including two motors may drive the rack bar. Based on the steering input of the driver, the two motors determine a target steering torque and move the rack bar based on the target steering torque in order to control the traveling direction of the vehicle. For this operation, two motors included in the power pack may move the rack bar at the same speed and force.

As previously described, two power packs according to an embodiment of the present disclosure compute the linear or sliding position of the rack bar based on the first and second position values of the motors sensed or determined from the motor sensors. The phase difference between the position values of the two motors depending on the sliding position of the rack bar may be required to determine the linear or sliding position of the rack bar.

For example, the outer diameter of the first motor pulley and the outer diameter of the second motor pulley may be different from each other, while the outer diameter of the first nut pulley and the outer diameter of the second nut pulley may be identical to each other. As another example, the outer diameter of the first motor pulley and the outer diameter of the second motor pulley may be identical to each other, while the outer diameter of the first nut pulley and the outer diameter of the second nut pulley may be different from each other. As yet another example, the outer diameter of the first motor pulley and the outer diameter of the second motor pulley may be different from each other, and the outer diameter of the first nut pulley and the other diameter of the second nut pulley may also be different.

First motor pulley teeth may be provided on the outer peripheral surface of the first motor pulley, and first nut pulley teeth may be provided on the outer peripheral surface of the first nut pulley. The first motor pulley teeth are engaged with first belt teeth provided on the inner peripheral surface of the first belt. Second motor pulley teeth may be provided on the outer peripheral surface of the second motor pulley, second nut pulley teeth may be provided on the outer peripheral surface of the second nut pulley, and the second motor pulley teeth may be engaged with second belt teeth provided on the inner peripheral surface of the second belt. The number of teeth may be adjusted to determine the linear or sliding position of the rack bar according to the phase difference of the motor.

For example, the number of the first motor pulley teeth and the number of the second motor pulley teeth may be different from each other, while the number of the first nut pulley teeth and the number of the second nut pulley teeth may be the same as each other. As another example, the number of the first motor pulley teeth and the number of the second motor pulley teeth may be the same as each other, while the number of the first nut pulley teeth and the number of the second nut pulley teeth may be different from each other. As yet another example, the number of the first motor pulley teeth and the number of the second motor pulley teeth may be different from each other, and the number of the first nut pulley teeth and the number of the second nut pulley teeth may also be different from each other.

A steer-by-wire system according to an embodiment may not include a pinion gear. And, a steer-by-wire system according to an embodiment may not comprise a rack position sensor, configured to detect the linear or sliding position of the rack bar based on the movement of the pinion gear. If the pinion gear or the rack position sensor is provided or installed in a steer-by-wire, manufacturing cost and weight of the system may increase.

As described with reference to FIG. 19, the electronic control device may determine the linear or sliding position of the rack bar based on the first position value of the first motor and the second position value of the second motor using a vernier algorithm. However, as the reduction ratio of the first motor pulley and the first nut pulley is set to be high, the range of the relative linear or sliding position becomes narrow. In this case, there is a limitation in accurately determining the absolute linear or sliding position.

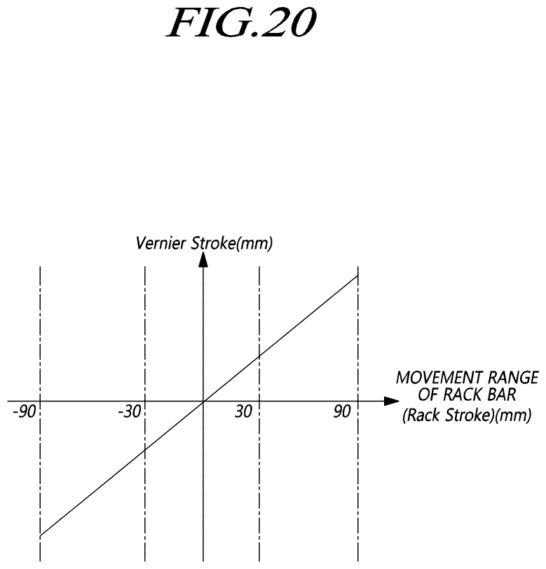

FIG. 20 is a graph for illustrating a method for determining a linear or sliding position of a rack bar using a motor rotational position according to an embodiment of the present disclosure.

Referring to FIG. 20, assuming that the entire movable range of the rack bar (rack stroke) is from −90 mm to 90 mm in the case of a low reduction ratio configuration, the linear or sliding position of the rack bar within the entire movable range may be determined using the vernier algorithm. A vernier stroke determined using the vernier algorithm for the entire movable range of the rack bar is linearly mapped one-to-one.

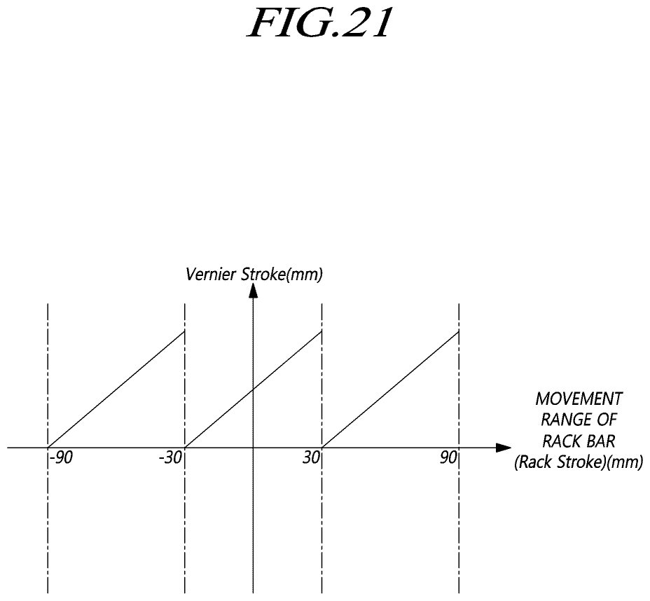

FIG. 21 is a graph for illustrating the results of determining a linear or sliding position of a rack bar according to a motor rotational position in a high reduction ratio situation according to an embodiment of the present disclosure.

Unlike FIG. 20, if the reduction ratios of the first motor pulley and the first nut pulley or the reduction ratios of the second motor pulley and the second nut pulley are configured with high reduction ratios, the range of the vernier stroke may be limited. That is, in the high reduction ratio situation, the movable range of the nut pulley according to the movement of the motor pulley is limited. Therefore, if the vernier stroke using the motor sensor configured to detect the position value is within one rotation of the motor, only the limited movemable range of the rack bar may be estimated.

For example, in FIG. 21, only the 60 mm range, among the full movable range of the rack bar, may be estimated as the vernier stroke. The relative linear or sliding position information is periodically repeated within each vernier stroke interval of −90 mm to −30 mm, −30 mm to 30 mm, and 30 mm to 90 mm. Therefore, even if the vernier stroke (relative sliding position information) is determined using the first position value and the second position value, the resulting value may correspond to any of three possible positions within the full movable range of the rack bar. In this situation, the electronic control device cannot determine which of the three possible linear or sliding position ranges the relative linear or sliding position actually represents.

The electronic control device according to an embodiment of the present disclosure may accurately determine or check the linear or sliding position of the rack bar using the first position value, the second position value, and the section information.

For example, the electronic control device may check the section information indicative of a section of the rack bar, among a plurality of sections of the rack bar, in which the rack bar is located based on the measured rack force value or the measured wheel angle, and may determine the linear or sliding position of the rack bar using the section information and the relative sliding position information determined using the first position value and the second position value. That is, the electronic control device determines the relative sliding position information based on the first position value and the second position value using the vernier algorithm. In addition, the electronic control device checks or determines a section where the rack bar is currently located, among a plurality of sections of the entire movement range of the rack bar, using the measured rack force value or the measured wheel angle. Therefore, the electronic control device may determine a final linear or sliding position of the rack bar using the relative sliding position information within the determined or checked section. Through this configuration, an embodiment of the present disclosure may enable a more versatile or flexible reduction ratio design environment, thereby enhancing a steering feel for the driver.

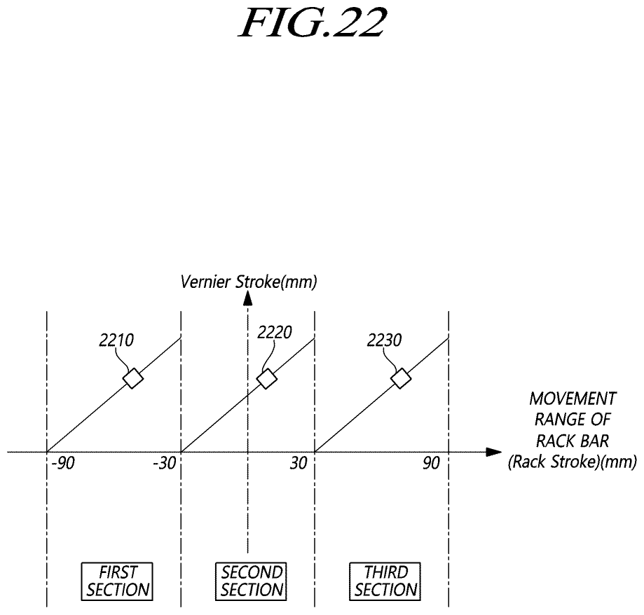

FIG. 22 is a diagram for illustrating a method for determining a linear position of a rack bar using section information according to an embodiment of the present disclosure.

Referring to FIG. 22, the full movable range of the rack bar is illustrated using an exemplary configuration in which the full movable range is divided into three sections. The number of sections is exemplary and may vary.

The rack bar may be divided into two or more sections, each defined as a preset portion of the maximum movable range of the rack bar. For instance, each section has the same length as another. By way of example, the range may be divided into three equal 60 mm sections (−90 to −30, −30 to 30, and 30 to 90). In this case, as described above, three vernier stroke values corresponding to the relative linear or sliding positions 2210, 2220, and 2230 may be identical. The electronic control device may use the section information to decide which of these values corresponding to the actual linear or sliding position of the rack bar, thereby determining the linear or sliding position of the rack bar.

The number of sections for checking the section information may be preset. For example, the preset number may be set based on at least one of the first reduction ratio determined by the first motor pulley and the first nut pulley and the second reduction ratio determined by the second motor pulley and the second nut pulley. As the reduction ratio is lower, the number of sections may be reduced. Conversely, as the reduction ratio is higher, the number of sections may increase.

For another example, the preset number may be set to increase or decrease depending on the movable range of the rack bar, which may be determined using the relative linear or sliding position information determined using the first position value and the second position value. For example, as the movable range of the rack bar (for example, vernier stroke) determined using the relative linear or sliding position information is lower, the number of sections may increase. Conversely, as the movable range of the rack bar (for example, vernier stroke) is larger, the number of sections may decrease.

The section information indicating a section where the rack bar is located may be determined or checked by comparing the measured rack force value or the measured wheel angle information with a reference rack force value or a reference angle range preset for each section of the rack bar.

For example, the electronic control device may determine or check a section in which the rack bar is located by identifying a section corresponding to a reference rack force value that matches the measured rack force value. As another example, the electronic control device may determine or check a section in which the rack bar is located by identifying a section corresponding to a reference angle range that matches the measured wheel angle. As yet another example, the electronic control device may determine or check a section information in which the rack bar is located based on a driving direction information of the vehicle by using a sensor such as a radar or lidar of the vehicle. In addition, the electronic control device may also check the section information using lateral acceleration information, yaw rate information, or other information that may indicate the direction of the vehicle.

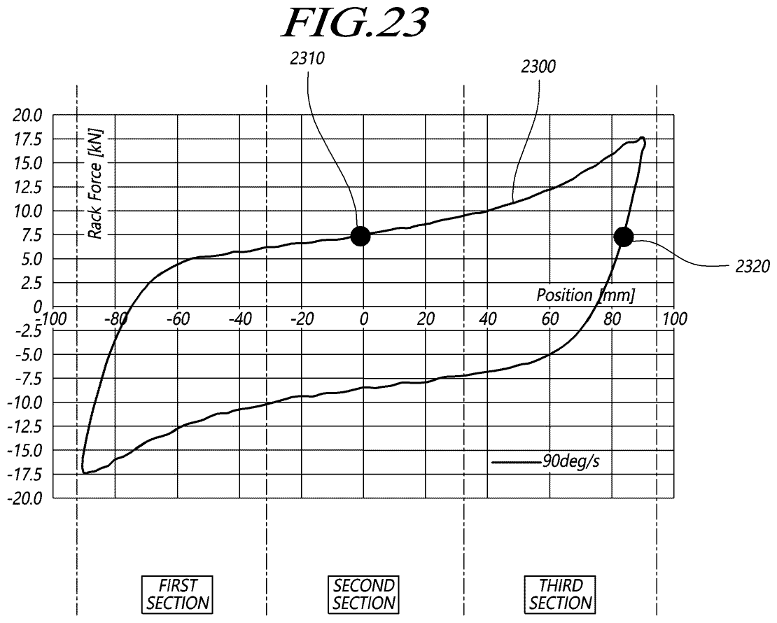

FIG. 23 is a graph for illustrating the setting of section information according to a rack force value according to an embodiment of the present disclosure.

Referring to FIG. 23, the electronic control device may use a rack force value to determine or check the section information indicative of a section where the relative linear or sliding position is located. For example, the electronic control device may determine the rack force value of the vehicle. The rack force value may be measured at regular intervals. The rack force value may be preset as a reference rack force value 2300 for each vehicle type or size. If three sections are set, the rack force value may differ in each section.

For example, the electronic control device may determine or check a section wherein the rack bar is located by using the rack force value of the vehicle to determine which reference rack force value 2300 corresponding to a specific section matches the determined (measured) rack force value. For example, when the measured rack force value is determined to be between −10 and −17.5, the corresponding reference rack force value exists only within the first section. Therefore, the electronic control device may identify the section corresponding to the measured rack force value as the first section.

However, the measured rack force value may, in some cases, fall within two sections or more. For example, if the measured rack force value is determined to be 7.5, the same value in the reference rack force value 2300 may appear at positions 2310 and 2320. Therefore, the electronic control device may need additional information to select one of positions 2310 and 2320 to determine the section information. For example, the electronic control device may additionally measure the rack force value at certain time intervals to check the fluctuation of the measured rack force value. In the case of 2310, the fluctuation range measured after a certain time may be significally smaller than that of 2320, which is associated with the third section. Using this, the electronic control device may ultimately determine or check the section information indicative of an appropriate section based on the rack force value.

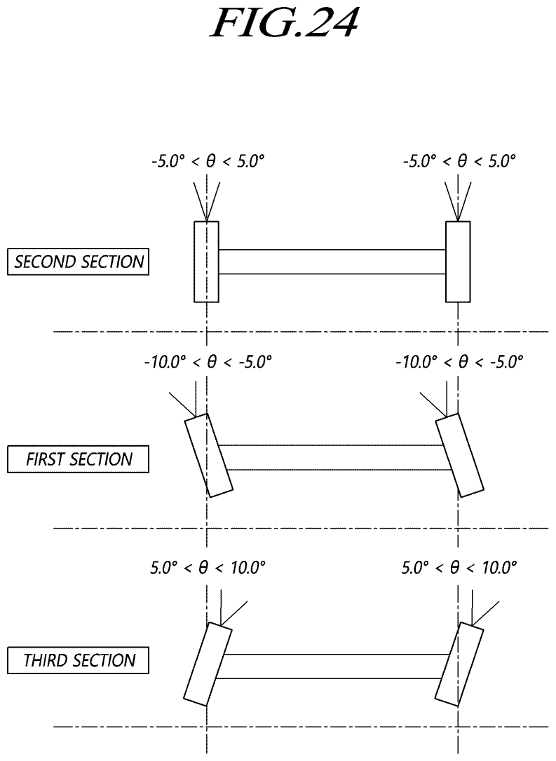

FIG. 24 is a diagram for illustrating examples for the setting of section information according to an wheel angle according to an embodiment of the present disclosure.

Referring to FIG. 24, the angle of the wheel may be determined using a sensor such as a camera installed in the vehicle. For example, the electronic control device may check section information based on the measured wheel angle information and a preset wheel angle range. The electronic control device may determine or check a section of the rack bar as the second section if the wheel angle information is between-5 degrees and 5 degrees. Similarly, the electronic control device may determine or check the section information for the first section and third sections based on a reference angle range to which the wheel angle information belongs.

For example, the wheel angle may be measured using a sensor such as a camera sensor configured to capture one or more wheel angles. For example, the wheel angle may be measured using an around-view camera sensor installed in the vehicle. Radar sensors, lidar sensors, and any other sensors that can directly or indirectly check the wheel angle may also be used. The wheel angle may also be indirectly measured using the direction and angle of movement of objects around the vehicle through the radar sensor or lidar sensor.

As described above, the electronic control device may determine or check section information using the rack force value or the wheel angle.

The electronic control device may determine the relative linear or sliding position information using the phase difference between the first position value of the first motor and the second position value of the second motor. The relative sliding position information may be determined using the vernier algorithm.

The electronic control device may determine the linear or sliding position of the rack bar within the entire movable range of the rack bar using the section information and the relative sliding position information. Accordingly, even in the steer-by-wire system or RWA system with the high reduction ratio, the absolute position information of the rack bar may be accurately determined without an additional detecting operation or a sensor configured to sense an absolute position of the rack bar.

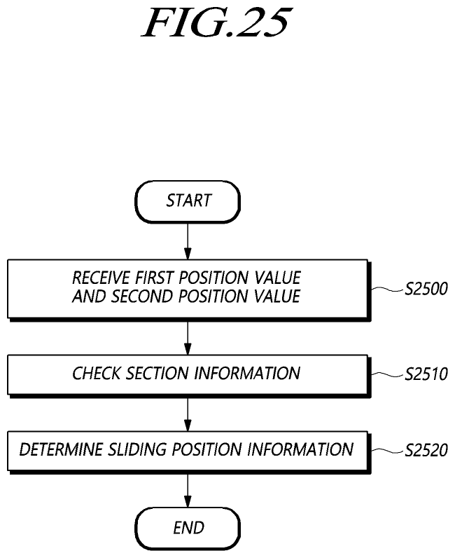

FIG. 25 is a flowchart for illustrating a method for determining a linear position of a rack bar according to an embodiment of the present disclosure.

Referring to FIG. 25, a method for determining a linear or sliding position of the rack bar may include step S2500 of receiving a first position value detected from a first motor sensor configured to detect the rotational position of the shaft of the first motor and a second position value detected from a second motor sensor configured to detect the rotational position of the shaft of the second motor.

For example, an apparatus (e.g. a controller or processor) for determining the linear or sliding position of the rack bar may receive the first position value and the second position value. Each value may be received from the motor sensor. In addition, the apparatus for determining the linear or sliding position of the rack bar may further receive a rack force value, an wheel angle, or any other information related to the rack bar.

In addition, the method for determining the linear or sliding position of the rack bar may include step S2510 of determining or checking a section where the rack bar is located, based on the measured rack force value or the measured wheel angle, from among two or more sections into which the rack bar is divided according to the movable range of the rack bar.

The method for determining the linear or sliding position of the rack bar may determine or check the section information indicative of a section in which the rack bar is located. The rack bar may be divided into two or more sections, each defined as a preset portion of the maximum movable range of the rack bar. For instance, each section has the same length as another. By way of example, the range may be divided into three equal sections. However, the preset number of sections of the rack bar may increase or decrease according to the maximum movable range of the rack bar, which may be determined based on sliding position information determined using the first position value and the second position value. As another example, the preset number of sections may be determined by the first reduction ratio determined by the first motor pulley and the first nut pulley and/or the second reduction ratio determined by the second motor pulley and the second nut pulley.

The section information indicative of a section where the rack bar is located may be determined or checked by comparing a reference rack force value or reference angle range preset for each section of the rack bar with the measured rack force value or the measured wheel angle. For example, when determining the section information, the electronic control device may identify a section to which a reference rack force value corresponding to the measured rack force value belongs as a section where the rack bar is located. As described above, if the measured rack force value corresponds to two or more sections, the section information may be determined or checked according to the variability of the measured rack force value measured at a certain time interval. The variability may be set according to the magnitude or speed of change of the measured rack force value, or may mean the magnitude or rate of change itself.

Alternatively, when determining section information, a section to which the reference angle range corresponding to the measured wheel angle belongs may be identified or checked as a section where the rack bar is located. For example, section information may be determined or checked based on a reference angle range to which an wheel angle measured by a sensor such as a camera belongs to. In addition, the section information classified according to the moving direction or wheel angle of the vehicle may be determined or checked using various sensors such as a radar sensor, a lidar sensor, a lateral acceleration sensor, and a yaw rate sensor.

In addition, the method for determining the linear or sliding position of the rack bar may include step S2520 of determining the linear or sliding position of the rack bar using relative sliding position information and section information determined using the first position value and the second position value.

For example, the relative sliding position information may be determined according to the phase difference between the first position value and the second position value. When determining the linear or sliding position of the rack bar, vernier stroke may be determined based on the first position value and the second position value using a vernier algorithm. When determining the linear or sliding position of the rack bar, a final linear or sliding position of the rack bar may be determined using the vernier stroke and the section information. The linear or sliding position information may be determined as a position of the rack bar indicated by the relative sliding position information within the movable range of the rack bar according to the section information.

The order of determining or checking the section information and determining the relative linear or sliding position information is not constrained. Either the section information may be determined or checked first or the relative linear or sliding position information may be determined first. Both the section information and the relative linear or sliding position information may be used to determine a final linear or sliding position information of the rack bar.

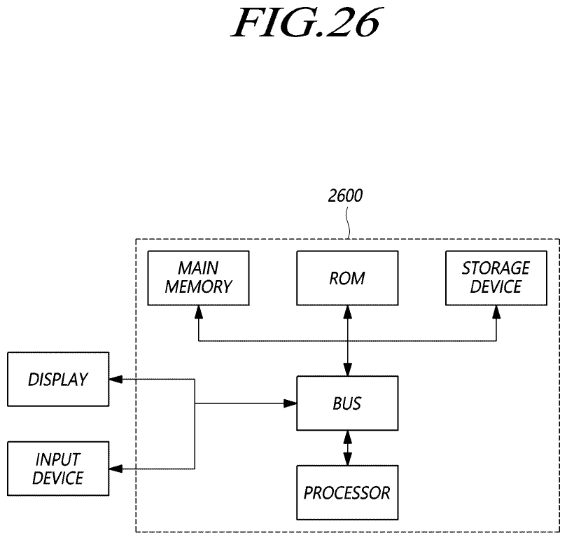

FIG. 26 is a block diagram for illustrating an apparatus for determining a linear or sliding position of a rack bar according to an embodiment of the present disclosure.

Referring to FIG. 26, an apparatus 2600 for determining a linear or sliding position of a rack bar may include a memory configured to store executable instructions for performing operations of the apparatus 2600 for determining or computing the linear or sliding position of the rack bar, and at least one processor configured to execute one or more of the instructions stored in the memory.

The processor may receive a first position value detected from a first motor sensor configured to detect a rotational position of a shaft of a first motor and a second position value detected from a second motor sensor configured to detect a rotational position of a shaft of a second motor, determine or check section information indicative of a section in which the rack bar is located based on a measured rack force value or an wheel angle from among a plurality of sections of the rack bar, and determine linear or sliding position of the rack bar using relative sliding position information determined based on the first position value and the second position value and the section information. The rack bar is divided into the plurality of sections according to the movement range of the rack bar

For example, the apparatus 2600 for determining the linear or sliding position of the rack bar may receive the first position value and the second position value from the first motor sensor and the second motor sensor, respectively. In addition, the apparatus 3600 for determining the linear or sliding position of the rack bar may receive the rack force value, the wheel angle, or an other information for determining the linear or sliding position of the rack bar.

The apparatus 2600 for determining the linear or sliding position of the rack bar may determine or check the section information indicative of a section in which the rack bar is located. The rack bar may be divided into two or more sections, each defined as a preset portion of the maximum movable range of the rack bar. For instance, each section has the same length as another. By way of example, the range may be divided into three equal sections. However, the preset number of sections of the rack bar may increase or decrease according to the maximum movable range of the rack bar, which may be determined based on sliding position information determined using the first position value and the second position value. As another example, the preset number of sections may be determined by the first reduction ratio determined by the first motor pulley and the first nut pulley and/or the second reduction ratio determined by the second motor pulley and the second nut pulley.

The section information indicative of a section where the rack bar is located may be determined or checked by comparing a reference rack force value or reference angle range preset for each section of the rack bar with the measured rack force value or the measured wheel angle. For example, the processor may identify a section to which a reference rack force value corresponding to the measured rack force value belongs as a section where the rack bar is located. As described above, if the measured rack force value corresponds to two or more sections, the section information may be determined or checked according to the variability of the measured rack force value measured at a certain time interval. The variability may be set according to the magnitude or speed of change of the measured rack force value, or may mean the magnitude or rate of change itself.

Alternatively, the processor may identify or check a section to which the reference angle range corresponding to the measured wheel angle belongs as a section where the rack bar is located. For example, section information may be determined or checked based on a reference angle range to which an wheel angle measured by a sensor such a camera belongs to. In addition, the section information classified according to the moving direction or wheel angle of the vehicle may be determined or checked using various sensors such as a radar sensor, a lidar sensor, a lateral acceleration sensor, and a yaw rate sensor.

For example, the relative sliding position information may be determined according to the phase difference between the first position value and the second position value. The processor may determine vernier stroke based on the first position value and the second position value using a vernier algorithm. The processor may determine a final linear or sliding position of the rack bar using the vernier stroke and the section information. The linear or sliding position information may be determined as a position of the rack bar indicated by the relative sliding position information within the movable range of the rack bar according to the section information.

The order of determining or checking the section information and determining the relative linear or sliding position information is not constrained. Either the section information may be determined or checked first or the relative linear or sliding position information may be determined first. Both the section information and the relative linear or sliding position information may be used to determine a final linear or sliding position information of the rack bar.

The apparatus 2600 for determining the linear or sliding position of the rack bar may include or implement one or more components such as a computing system or data processing system. The computing system (e.g., a computer) may include a bus or other communication component such as a communicator configured to receiving or transmitting information, and a processor or processing circuit communicationally or electronically connected to the bus for processing the information. The computing system may include one or more processors or processing circuits connected to the bus for processing the information. The computing system may include a main memory, such as a random access memory (RAM) or other dynamic storage device, connected to the bus for storing information, and commands (i.e., instructions) to be executed by the processor. The main memory may be or include a data storage device. The main memory may also be configured to store location information, temporary variables, or other intermediate information during execution of commands by the processor. The computing system may include a read-only memory (ROM) or other static storage device connected to the bus for storing static information and instructions for the processor. A storage device, such as a solid-state device, magnetic disk, or optical disk, may be coupled to the bus for persistent storage of information and instructions. The storage device may include or be part of the data storage device.

The electronic control device may be electronically or communicationally connected via the bus to a display, such as a liquid crystal display or active matrix display, for outputting or displaying information to a user. An input device, such as a keyboard including alphanumeric and other keys, may be electronically or communicationally connected to the bus for communicating information and commands to the processor. The input device may include a touch screen display. The input device may include a cursor control, such as a mouse, a trackball, or cursor direction keys, for receiving or communicating direction information and command selections to the processor and for controlling cursor movement on a display. The display can be part of a data processing system, a client computing device or other component of a system.

The processes and methods described herein can be performed by executing instructions in the main memory by the processor. Such instructions can be stored in the main memory read from another computer-readable medium, such as the storage device. Execution of the instructions stored in the main memory causes the electronic control device to perform the processes or methods described herein. One or more processors in a multiprocessing arrangement may be included in the electronic control device to execute the instructions stored in the main memory. Hard-wired circuitry can be used in association with software instructions together with the systems and methods described herein. Systems and methods described herein are not limited to any specific combination of hardware circuitry and software.

Although an example of the electronic control device has been described, the operations described in this specification can be implemented in other types of digital electronic circuitry, or in computer software, firmware, or hardware, including the structures disclosed in this specification and their structural equivalents, or in combinations of one or more of them.

The terms “data processing system,” “computing device,” “component,” or “data processing apparatus” encompass various apparatuses, devices, and machines for processing data, including a programmable processor, a computer, a system on a chip, or multiple ones, or combinations of the foregoing. Those terms can include special-purpose logic circuitry, e.g., an FPGA (field-programmable gate array) or an ASIC (application-specific integrated circuit). The terms can also include code that creates an execution environment for the computer program, e.g., code that constitutes processor firmware, a protocol stack, a database management system, an operating system, a cross-platform runtime environment, a virtual machine, or a combination of one or more of them. The apparatus and execution environment can implement various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can be implemented as a file in a file system. A computer program can be stored in a portion of a file that holds other programs or data (e.g., one or more scripts stored in a markup language document), in a single file dedicated to the program, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs (e.g., components of the data processing system) to perform actions by operating on input data and generating output. The processes and logic flows can also be performed by, and apparatuses can also be implemented as, special purpose logic circuitry, e.g., an FPGA (field-programmable gate array) or an ASIC (application-specific integrated circuit). Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

According to some embodiments of the present disclosure, even though there is no mechanical connection between a steering shaft and a road wheel in a steer-by-wire steering apparatus, the driver's steering intention may be stably transmitted to a rack bar, and the rack bar may be prevented from being rotated by rotational torque of a ball nut when the driver manipulates the steering wheel.

In addition, according to certain embodiments of the present disclosure, the position of a rack bar may be accurately estimated without a pinion shaft.

The subject matter and the operations described in this specification can be implemented in digital electronic circuitry or in computer software, firmware, or hardware, including the structures disclosed in this specification and their structural equivalents, or in combinations of one or more of them. The subject matter described in this specification can be implemented as one or more computer programs, e.g., computer program instructions of one or more circuits, stored or encoded in one or more computer storage media for execution by one or more data processing apparatuses or control of the operations of one or more data processing apparatuses. Alternatively or additionally, the program instructions can be encoded on an artificially generated propagated signal, e.g., a machine-generated electrical, optical, or electromagnetic signal that is generated to encode information for transmission to a suitable receiver apparatus for execution by a data processing apparatus. A computer storage medium may be included in a computer-readable storage device, a computer-readable storage substrate, a random or serial-access memory array or device, or a combination of one or more of them. While a computer storage medium may not be a propagated signal, a computer storage medium can be a source or destination of computer program instructions encoded in an artificially generated propagated signal. The computer storage medium may be included in one or more separate components or media (e.g., multiple CDs, disks, or other storage devices). The operations described in this specification can be implemented as operations performed by a data processing apparatus on data stored on one or more computer-readable storage devices or received from other sources.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims.

What is claimed is:

1. A steer-by-wire system comprising:
a rotatable nut operably coupled to a rack bar and configured to linearly move the rack bar by rotation of the rotatable nut;
a first nut pulley provided on an outer surface of the ball nut;
a second nut pulley provided on the outer surface of the ball nut;
a first motor pulley of a first motor operably connected to the first nut pulley;
a second motor pulley of a second motor operably connected to the second nut pulley; and
a processor programmed to determine a linear position of the rack bar based on a first position of the first motor detected by a first motor sensor configured to detect a rotational position of the first motor, a second position of the second motor detected by a second motor sensor configured to detect a rotational position of the second motor, and a section where the rack bar is located among a plurality of sections dividing an movable range of the rack bar.

2. The steer-by-wire system of claim 1, wherein the processor is programmed to determine the section where the rack bar is located, from among the plurality of sections dividing the movable range of the rack bar, based on a measured rack force or a measured angle of a vehicle wheel, and determine the linear position of the rack bar based on relative linear position information, determined based on the first position of the first motor and the second position of the second motor, and the section where the rack bar is located among the plurality of sections dividing the movable range of the rack bar.

3. The steer-by-wire system of claim 1, wherein an outer diameter of the first motor pulley and an outer diameter of the second motor pulley are different from each other and an outer diameter of the first nut pulley and an outer diameter of the second nut pulley are identical to each other.

4. The steer-by-wire system of claim 1, wherein an outer diameter of the first motor pulley and an outer diameter of the second motor pulley are identical to each other and an outer diameter of the first nut pulley and an outer diameter of the second nut pulley are different from each other.

5. The steer-by-wire system of claim 1, wherein an outer diameter of the first motor pulley and an outer diameter of the second motor pulley are different from each other and an outer diameter of the first nut pulley and an outer diameter of the second nut pulley are different from each other.

6. The steer-by-wire system of claim 1, wherein a number of teeth of the first motor pulley and a number of the second motor pulley are different from each other and a number of teeth of the first nut pulley and a number of teeth of the second nut pulley are identical to each other.

7. The steer-by-wire system of claim 1, wherein a number of teeth of the first motor pulley and a number of teeth of the second motor pulley are identical to each other, and a number of teeth of the first nut pulley and a number of teeth of the second nut pulley are different from each other.

8. The steer-by-wire system of claim 1, wherein a number of teeth of the first motor pulley and a number of teeth of the second motor pulley are different from each other, and a number of teeth of the first nut pulley and a number of teeth of the second nut pulley are different from each other.

9. The steer-by-wire system of claim 1, wherein the movable range of the rack bar is divided into the plurality of sections, each having an equal size.

10. The steer-by-wire system of claim 9, wherein a number of the plurality of sections into which the movable range of the rack bar is divided is set based on at least one of a first reduction ratio of the first motor pulley and the first nut pulley and a second reduction ratio of the second motor pulley and the second nut pulley.

11. The steer-by-wire system of claim 2, wherein a number of the plurality of sections into which the movable range of the rack bar is divided is set based on the relative linear position information determined based on the first position of the first motor and the second position of the second motor.

12. The steer-by-wire system of claim 2, wherein the processor is programmed to determine the section where the rack bar is located by comparing the measured rack force or the measured angle of the vehicle wheel with a reference rack force value or a reference angle range preset for each of the plurality of sections dividing the movable range of the rack bar.

13. The steer-by-wire system of claim 12, wherein the processor is programmed to:
determine a section to which the reference rack force value corresponding to the measured rack force belongs as the section where the rack bar is located, or
determine a section to which the reference angle range corresponding to the measured angle of the vehicle wheel belongs as the section where the rack bar is located.

14. The steer-by-wire system of claim 2, wherein the processor is programmed to determine the relative sliding position information based on the first position of the first motor and the second position of the second motor using a vernier algorithm.

15. The steer-by-wire system of claim 2, wherein the processor is programmed to determine the the linear position of the rack bar determined based the relative sliding position information within a range of the section where the rack bar is located among the plurality of sections dividing the movable range of the rack bar.

16. A method for controlling a steer-by-wire system, the method comprising:
receiving a first position of a first motor from a first motor sensor configured to detect a rotational position of the first motor and a second position of a second motor from a second motor sensor configured to detect a rotational position of the second motor;
determining a section where a rack bar is located, from among a plurality of sections dividing a movable range of the rack bar, based on a measured rack force or a measured angle of a vehicle wheel; and
determining a linear position of the rack bar based on the first position of the first motor, the second position of the second motor, and the section where the rack bar is located among the plurality of sections dividing the movable range of the rack bar.

17. The method of claim 16, wherein the movable range of the rack bar is divided into the plurality of sections, each having an equal size.

18. The method of claim 16, wherein the determining of the section where the rack bar is located comprises comparing the measured rack force or the measured angle of the vehicle wheel with a reference rack force value or a reference angle range preset for each of the plurality of sections dividing the movable range of the rack bar to determine the section where the rack bar is located among the plurality of sections.

19. The method of claim 18, wherein the determining of the section where the rack bar is located comprises:
determining a section to which the reference rack force value corresponding to the measured rack force belongs as the section where the rack bar is located, or
determining a section to which the reference angle range corresponding to the measured angle of the vehicle wheel belongs as the section where the rack bar is located.

20. A non-transitory computer-readable storage medium having instructions that, when executed by one or more processors, cause the one or more processors to:
receive a first position of a first motor from a first motor sensor configured to detect a rotational position of the first motor and a second position of a second motor from a second motor sensor configured to detect a rotational position of the second motor;
determine a section where a rack bar is located, from among a plurality of sections dividing a movable range of the rack bar, based on a measured rack force or a measured angle of a vehicle wheel; and
determining a linear position of the rack bar based on the first position of the first motor, the second position of the second motor, and the section where the rack bar is located among the plurality of sections dividing the movable range of the rack bar.
